(19) United States
(12) Patent Application Publication
(10) Pub. No.: US 2026/0289436 A1
(43) Pub. Date: Sep. 24, 2026

(54) SYSTEM AND METHODS FOR BROKERING AND MANAGING AUTOMATED SEAT PREFERENCES AND REASSIGNMENTS

(71) Applicant: UNITED AIRLINES, INC., Chicago, IL (US)

(72) Inventors: Hemanth Kumar Madala, Chicago, IL (US); Courtney McHugh, Chicago, IL (US); Tim Lattimer, Chicago, IL (US); Michael Leung, Chicago, IL (US); Raul Esquivel, Chicago, IL (US)

(21) Appl. No.: 19/571,884

(22) Filed: Mar. 19, 2026

Related U.S. Application Data
(60) Provisional application No. 63/775,274, filed on Mar. 20, 2025.

(51) Int. Cl. G06Q 10/02

(52) U.S. Cl. CPC G06Q 10/0283; G06Q 10/027

(57) ABSTRACT

A seat reservation system may detect an open seat event indicating availability of a new open seat for a scheduled flight, suspend manual seat change requests, generate a final seat reassignment plan that fills the new open seat and subsequently opened seats from passengers on an assignment waitlist using seat preference data, update the assignment waitlist to remove reassigned passengers, transmit notifications of new seat assignments to user devices associated with reassigned passengers, and reenable manual seat change requests in response to selecting the final seat reassignment plan.

### CROSS-REFERENCE TO RELATED APPLICATIONS

This application claims priority to and the benefit of the filing date of provisional U.S. Patent Application No. 63/775,274 entitled “System and Methods for Brokering and Managing Automated Seat Preferences and Reassignments” filed on Mar. 20, 2025, the entire contents of which are hereby expressly incorporated herein by reference.

### FIELD OF THE DISCLOSURE

The present disclosure relates generally to techniques for managing seat assignments in different services. More specifically, the present disclosure pertains to techniques for dynamically assigning seats based on user preferences and seat availability, thereby improving the efficiency of seat allocation processes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In transportation services, particularly in commercial air travel, passengers frequently encounter difficulties in securing preferred seating arrangements. Airlines typically allow customers to select seats at the time of booking, but the availability of preferred seats remains uncertain due to fluctuations in inventory caused by cancellations, upgrades, operational adjustments, and other factors.

Currently, when a desired seat is unavailable at the time of booking, passengers must manually monitor seat maps for potential openings. This process requires repeated checks and, in many cases, relies on passengers refreshing the seat selection interface to identify newly available seats. Since seat reassignments often operate on a first-come, first-served basis, passengers who do not actively monitor seat availability may miss opportunities to secure a more desirable seat.

Existing systems primarily facilitate seat selection at the time of booking or during check-in but do not provide an efficient mechanism for passengers to express ongoing seating preferences after booking. Furthermore, conventional methods for seat selection do not account for user-specific preferences beyond basic attributes. For example, the conventional methods do not provide options such as window, aisle, extra legroom, group seatings, etc.

Given these limitations, there remains a need for improved techniques that allow passengers to specify seat preferences dynamically, enabling more efficient and automated seat allocation based on real-time seat availability and pre-determined qualification criteria.

### SUMMARY

In some aspects, the techniques described herein relate to a method of assigning a user to an open seat for a seat reservation, the method including: providing, by one or more processors, a plurality of seat preference options for a seat reservation to a user via a user device; receiving, by the one or more processors, seat preference data from the user via the user device in response to the plurality of seat preference options; applying, by the one or more processors, a qualification engine to determine whether the user meets a qualification for assignment; placing, by the one or more processors, the user in an assignment waitlist based on the seat preference data upon the user meeting the qualification; receiving, by the one or more processors, an open seat event indicating availability of an open seat; selecting, by the one or more processors, a designated user from the assignment waitlist based on one or more seat preference data of one or more users, wherein the designated user is the user; updating, by the one or more processors, the assignment waitlist by removing the designated user; transmitting, by the one or more processors, a notification of the assignment to the user device; and assigning, by the one or more processors, the designated user to the open seat, wherein the open seat matches at least a portion of the seat preference data from the designated user.

In some aspects, the techniques described herein relate to a seat reservation system comprising: one or more processors; and one or more non-transitory, computer-readable media storing instructions that, when executed by the one or more processors, cause the seat reservation system to: provide, by the one or more processors, a plurality of seat preference options for a seat reservation to a user via a user device; receive, by the one or more processors, seat preference data from the user via the user device in response to the plurality of seat preference options; apply, by the one or more processors, a qualification engine to determine whether the user meets a qualification for assignment; place, by the one or more processors, the user in an assignment waitlist based on the seat preference data upon the user meeting the qualification; receive, by the one or more processors, an open seat event indicating availability of an open seat; select, by the one or more processors, a designated user from the assignment waitlist based on one or more seat preference data of one or more users, wherein the designated user is the user; update, by the one or more processors, the assignment waitlist by removing the designated user; transmit, by the one or more processors, a notification of the assignment to the user device; and assign, by the one or more processors, the designated user to the open seat, wherein the open seat matches at least a portion of the seat preference data from the designated user.

In some aspects, the techniques described herein relate to a seat reservation system including: one or more processors; and one or more non-transitory, computer-readable media storing instructions that, when executed by the one or more processors, cause the seat reservation system to: detect an open seat event indicating availability of a new open seat for a scheduled flight; suspend manual seat change requests in response to detecting the open seat event; generate a final seat reassignment plan for the scheduled flight, wherein the final seat reassignment plan fills the new open seat and one or more subsequently opened seats from passengers included on an assignment waitlist using seat preference data for each passenger included on the assignment waitlist, and wherein the one or more subsequently opened seats include seats opened in response to filling of the new open seat with a passenger from the assignment waitlist; update the assignment waitlist to remove reassigned passengers moved to the new open seat and subsequently opened seats in the final seat reassignment plan; transmit one or more notifications of new seat assignments from the final seat reassignment plan to user devices associated with the reassigned passengers; and reenable the manual seat change requests in response to selecting the final seat reassignment plan.

In some aspects, the techniques described herein relate to a method of generating a final seat reassignment plan for a scheduled flight in response to an open seat event, the method including: detecting, by one or more processors, the open seat event indicating availability of a new open seat for the scheduled flight; suspending, by the one or more processors, manual seat change requests in response to detecting the open seat event; generating, by the one or more processors, a final seat reassignment plan for the scheduled flight, wherein the final seat reassignment plan fills the new open seat and one or more subsequently opened seats from passengers included on an assignment waitlist using seat preference data for each passenger included on the assignment waitlist, and wherein the one or more subsequently opened seats include seats opened in response to filling of the new open seat with a passenger from the assignment waitlist; updating, by the one or more processors, the assignment waitlist to remove reassigned passengers moved to the new open seat and subsequently opened seats in the final seat reassignment plan; transmitting, by the one or more processors, one or more notifications of new seat assignments from the final seat reassignment plan to user devices associated with the reassigned passengers; and reenabling, by the one or more processors, the manual seat change requests in response to selecting the final seat reassignment plan.

In some aspects, the techniques described herein relate to a tangible, non-transitory computer-readable medium storing instructions for generating a final seat reassignment plan for a scheduled flight in response to an open seat event, wherein the instructions, when executed by one or more processors of a seat reservation system, cause the seat reservation system to: detect the open seat event indicating availability of a new open seat for the scheduled flight; suspend manual seat change requests in response to detecting the open seat event; generate a final seat reassignment plan for the scheduled flight, wherein the final seat reassignment plan fills the new open seat and one or more subsequently opened seats from passengers included on an assignment waitlist using seat preference data for each passenger included on the assignment waitlist, and wherein the one or more subsequently opened seats include seats opened in response to filling of the new open seat with a passenger from the assignment waitlist; update the assignment waitlist to remove reassigned passengers moved to the new open seat and subsequently opened seats in the final seat reassignment plan; transmit one or more notifications of new seat assignments from the final seat reassignment plan to user devices associated with the reassigned passengers; and reenable the manual seat change requests in response to selecting the final seat reassignment plan.

### BRIEF DESCRIPTION OF THE DRAWINGS

FIG. 1 illustrates a block diagram of an example communication system in which a method for assigning a user to an open seat for a seat reservation can be implemented.

FIG. 2 illustrates a block diagram of an example client computing device that can operate in the system of FIG. 1.

FIG. 3 illustrates a block diagram of an example assignment server that can operate in the system of FIG. 1.

FIG. 4 illustrates a flow diagram that depicts assigning a user to an open seat for a seat reservation using an example client computing device of FIG. 2 and an example assignment server of FIG. 3.

FIG. 5A-5D illustrate example user interfaces that a user may navigate in a reservation application to select a seat preference, according to some embodiments.

FIG. 6 depicts an example block flow diagram for assigning a user to an open seat for a seat reservation, according to some embodiments.

FIGS. 7A-7E illustrate additional example seat reservation systems and associated seat reassignment processes.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Broadly speaking, the techniques of the present disclosure relate to a system for assigning a user to an open seat for a seat reservation. In operation, the system may provide a plurality of seat preference options for a seat reservation to a user via a user device, receive seat preference data from the user, apply a qualification engine to determine the user meets the qualification, place the user in an assignment waitlist, receive an open seat event indicating availability of an open seat, select a designated user from the assignment waitlist, transmit a notification of the assignment to the user device, assign the designated user to the open seat, and update the assignment waitlist by removing the designated user.

Conventional seat reservation systems often require users to manually monitor seat availability and update their assignments as inventory changes. This process may be inefficient, as users frequently refresh seat maps or contact customer service agents in an attempt to secure preferred seating when seats become available (e.g., due to cancellations or reassignments). The repeated actions of users checking for open seats may generate unnecessary data traffic, potentially straining the seat reservation system and affecting its overall performance. Furthermore, open seat availability is often determined on a first-come, first-served basis, without considering user characteristics such as age, disability, or other priority factors. As a result, users are incentivized to actively monitor the system, further increasing data traffic and placing additional load on reservation infrastructure. This approach may also lead to suboptimal seat allocation, as open seats are not necessarily assigned to users with the greatest need. Additionally, conventional systems generally process seat assignments in a static manner, where user preferences are either not accounted for or disregarded after the initial booking. As a result, modifications to seat assignments typically require manual intervention, placing the burden on users to continuously check for availability and adjust their reservations. These limitations contribute to inefficiencies in seat allocation workflows and increase the operational burden on both users and seat reservation systems.

The present techniques improve seat assignment functionality by implementing a structured, automated preference-based allocation mechanism. Unlike conventional systems that require users to manually select a specific seat when it becomes available, the present techniques utilize an assignment waitlist that stores user preference data (e.g., window seat, aisle seat, extra legroom) of different users. When an open seat becomes available, the present techniques may evaluate the assignment waitlist in real time to identify a user whose preferences align with the open seat. The present techniques may then dynamically assign the seat to the most suitable user, ensuring an optimized and efficient allocation process. By automating seat assignments based on stored preference data, users no longer need to constantly monitor seat availability, reducing unnecessary data traffic and computational load on the system. Additionally, the present techniques may automatically notify users when a seat matching their preference becomes available, further minimizing manual intervention and streamlining the seat reassignment process.

Additionally, the present techniques optimize seat allocation by considering all users'preferences rather than relying on a first-come, first-served approach, where the first user to spot and book an available seat secures it. Instead of assigning seats solely based on the order of selection, the present techniques evaluate multiple factors, including user preference data, profile information, reservation history, and other relevant criteria, to maximize the number of users receiving their preferred seats. For example, the system may prioritize assigning extra legroom seating to an elderly passenger over a younger, physically fit passenger. In another example, if an open seat becomes available and the adjacent seat's occupant has not submitted any seating preferences, the system may reassign the adjacent seat to a different location, allowing two users who have indicated a preference to sit together to be seated next to each other. By incorporating user profile information, the present techniques may allocate open seats in a manner that prioritizes users with the greatest need, ensuring a more equitable and efficient seat assignment process.

The present techniques also enhance the responsiveness of seat reservation systems by integrating automated notifications with preference-based reassignments that include a confirmation period. For instance, after automatically reassigning a user's seat based on stored seat preference data, the present techniques may provide a notification allowing the user to confirm or decline the reassignment within a predetermined time. This enables the system to accommodate last-minute changes in user preferences, allowing users to reconsider and reject an assignment if they determine the newly assigned seat is undesirable. By providing a structured confirmation process, the present techniques may enhance flexibility in seat reassignment while ensuring that unconfirmed seats remain available for other users.

The present techniques improve the overall reliability of seat assignment systems by reducing inefficiencies associated with manual seat selection and ensuring that seating preferences are dynamically processed in an automated and structured manner. By integrating user's seat preference data and automated reassignment mechanisms based on the assignment waitlist, the present techniques provide a more responsive and intelligent seat management solution that enhances user experience while optimizing seat allocation processes, reduce data traffic, and enhance computational time.

### Example Hardware and Software Components

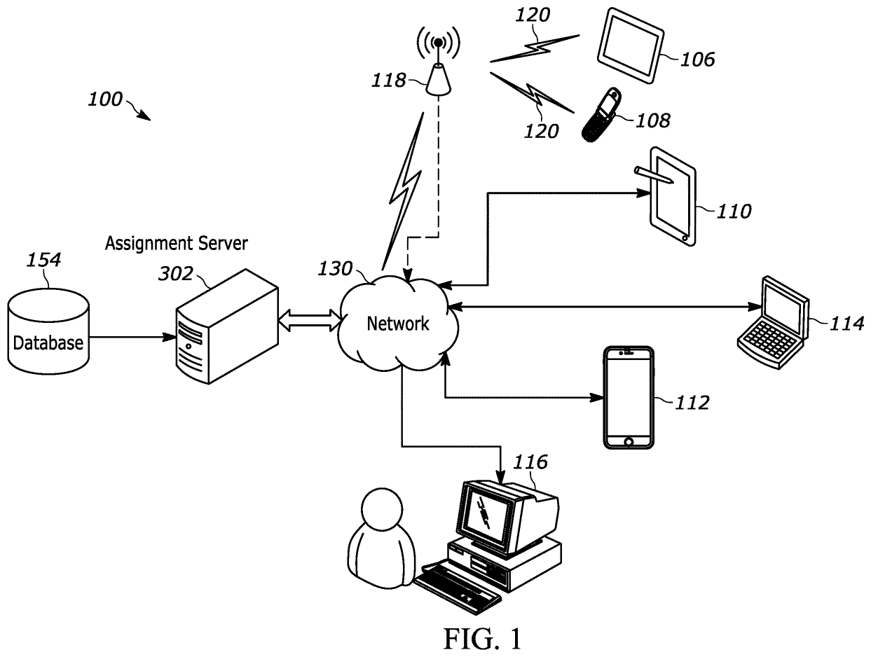

Referring to FIG. 1, an example comprehensive seat assignment system 100 includes an assignment server 302 and client devices 106-116 which may be communicatively connected through a network 130, as described below. The assignment server 302 may have an associated database 154 for storing travel information related to the operation of the comprehensive seat assignment system 100 such as available seat assignments on each departing travel, passenger information, an assignment waitlist, passenger seat preference data, vehicle information, etc.

The client devices 106-116 may include, by way of example, a tablet computer 106, a network-enabled cell phone 108, a personal digital assistant (PDA) 110, a mobile device smart-phone 112 also referred to herein as a “mobile device,” a laptop computer 114, a desktop computer 116, a portable media player (not shown), a wearable computing device (not shown), a smart watch, a phablet, any device configured for wired or wireless RF (Radio Frequency) communication, etc. Of course, any network-enabled device appropriately configured may interact with the comprehensive seat assignment system 100.

The network-enabled devices 106-116 need not necessarily communicate with the network 130 via a wired connection. The assignment server 302 may communicate with the client devices 106-116 via wireless signals 120 over a digital network 130, which can be any suitable local or wide area network(s) including a Wi-Fi network, a Bluetooth network, a cellular network such as 3G, 4G, Long-Term Evolution (LTE), 5G, the Internet, etc. In some instances, the client devices 106-116 may communicate with the digital network 130 via an intervening wireless or wired device 118, which may be a wireless router, a wireless repeater, a base transceiver station of a mobile telephony provider, etc.

Each of the client devices 106-116 may interact with the assignment server 302 to transmit seat preference data. The client devices 106-116 allow users to access the assignment server 302 from various environments and interfaces, such as API calls, chat interfaces, or other application integrations. Upon receiving the seat preference data, the assignment server 302 may process the data and, when an open seat becomes available, assign the user to a seat that matches their specified preferences. The assignment server 302 may then transmit the response (e.g., a notification of the matched seat) to the client devices 106-116.

In some embodiments, each of the client devices 106-116 may communicate with the assignment server 302 to manage seat reservations. Users may utilize the client devices 106-116 to perform standard seat booking functions, such as reserving, canceling, or modifying seat assignments. For example, a user may use a mobile phone 112 to book a seat for a flight to a desired destination. The mobile phone may then transmit the seat reservation request through the network 130 to the assignment server 302, which processes the request and confirms the seat assignment accordingly.

The assignment server 302 may be communicatively connected to a database 154, which stores various types of user-related and seat assignment information. The database 154 may maintain a wide range of data to facilitate optimized seat allocation and reservation management. The database 154 may store user profile information, including age, disability status, phone number, past seating history, frequent travel routes, and loyalty program status. Additionally, the database 154 may store transportation vehicle information, such as details about the type of vehicle (e.g., airplane, train, bus, etc.), the total number of seats available, seat layout configurations, seat class information (e.g., economy, business, first-class), and real-time occupancy status. The database 154 may also maintain seat reservation records, which include information about currently assigned seats, upcoming departures, seat changes, cancellation records, and priority seating requests.

The database 154 may also comprise data regarding open seat reservation information. The database 154 may comprise seat preference data for each corresponding user of a vehicle, and an assignment waitlist, which is a database of users who have subscribed for reassignment when an open seat matching their preferences becomes available. The seat preference data may be user's selection of seat preference options may including at least one of: a window seat, an aisle seat, a middle seat with extra legroom, adjacent seats with another user, avoidance of exit row seats, avoidance of bulkhead seats, avoidance of middle seats, or avoidance of middle seats with extra legroom.

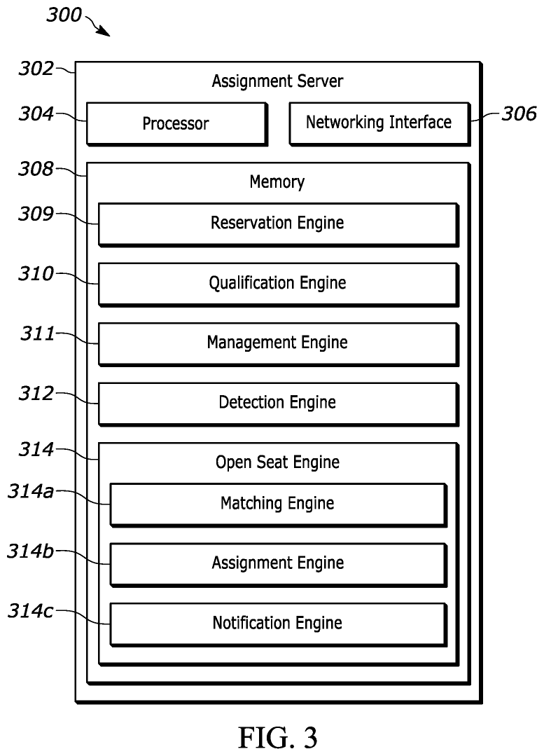

In some embodiments, the database 154 may store training data, including user preference data, vehicle information, user profiles, and other relevant data, to account for various scenarios in training one or more machine learning models, such as the matching machine learning model (facilitated by the matching engine 314a) and the managing machine learning model (facilitated by the management engine 311). The matching machine learning model, upon detecting an open seat event, may identify a user whose seat preference data aligns with the available seat criteria. For example, if a window seat becomes available, the matching machine learning model may select a user who is most suitable candidate for reassignment. The managing machine learning model may generate or update the assignment waitlist based on user preference data, vehicle information, user profile information, and other relevant factors. For example, the managing machine learning model may create a prioritized assignment waitlist by ranking users according to their eligibility for an open seat in the event of an open seat becoming available. This ranking may be determined based on criteria such as user profile information, vehicle specifications, seating preferences, and historical booking patterns to ensure optimized and fair seat reassignment. Details to the matching machine learning model and the managing machine learning model may be further described in FIG. 3.

The one or more machine learning models of the assignment server 302 that use a machine learning model may be configured to implement machine learning, such that the model/engine “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one machine learning method and algorithm may be applied, which may include, but is not limited to, the following: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of several categorizations of machine learning, such as supervised learning, unsupervised learning, and reinforcement learning.

In one embodiment, the one or more machine learning models may employ supervised learning, which involves identifying patterns in existing data to make predictions about subsequently received data. Specifically, the one or more machine learning models may be “trained” using training data, which includes example inputs and associated example outputs. Based upon the training data, the one or more machine learning models may generate a predictive function which maps outputs to inputs and may utilize the predictive function to generate machine learning outputs based upon data inputs.

In another embodiment, the one or more machine learning models may employ unsupervised learning, which involves finding meaningful relationships in unorganized data. Unlike supervised learning, unsupervised learning does not involve user-initiated training based upon example inputs with associated outputs. Rather, in unsupervised learning, the one or more machine learning models may organize unlabeled data according to a relationship determined by at least one machine learning method/algorithm employed by the one or more machine learning models. Unorganized data may include any combination of data inputs and/or machine learning outputs as described above.

In yet another embodiment, the one or more machine learning models may employ reinforcement learning, which involves optimizing outputs based upon feedback from a reward signal. Specifically, the one or more machine learning models may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

After training, machine learning programs (or information generated by such machine learning programs) may be used to evaluate additional data. Such data may be and/or may be related to intent data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset.

It is to be understood that supervised machine learning and/or unsupervised machine learning may also comprise retraining, relearning, or otherwise updating models with new, or different, information, which may include information received, ingested, generated, or otherwise used over time.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

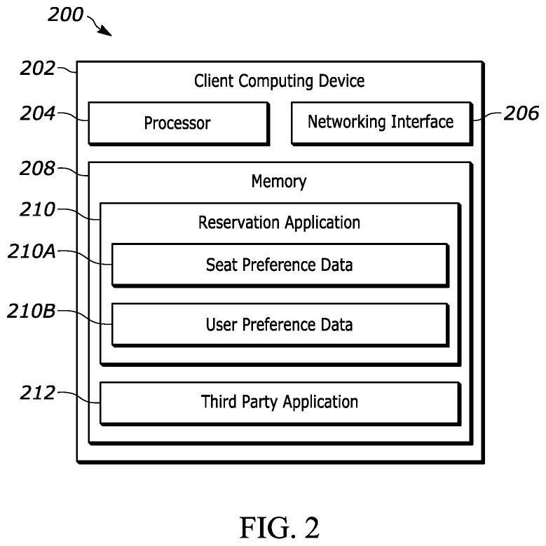

Turning now to FIG. 2, the client computing device 202 may include one or more processors 204, a networking interface 206, and one or more memories 208. The memories 208 may comprise a reservation application 210 including seat preference data 210A and user preference data 210B data, and a third party application 212.

A user may utilize the client computing device 202 to perform various seat reservation functions via a reservation application 210, such as booking a seat, canceling a reservation, modifying a seat selection, and subscribing to an open seat event when a preferred seat becomes available. Through the reservation application 210, the user may manage their travel preferences and automate seat reassignment requests without needing to manually monitor seat availability.

The reservation application 210 may present a user with a plurality of seat preference options to enhance the seat reservation experience. For example, the reservation application 210 may provide the user with the plurality of seat preference options after a seat reservation is confirmed, allowing them to specify preferences for future reassignments. Alternatively, the reservation application 210 may provide the user with the plurality of seat preference options during the checkout process, enabling users to define their seating preferences at the time of booking. The user may enter seat preference data 210A in response to the available plurality of seat preference options, selecting attributes such as window seat, aisle seat, extra legroom, or avoidance of specific seat types. In some embodiments, the user may provide user preference data 210B, allowing the user to specify passengers in the same flight with whom the prefer to sit with.

In some embodiments, the user may utilize a third-party application 212 hosted by a third-party reservation server to perform seat reservations and/or subscribe to seating reassignment services. For example, if a travel company may offer a bundled travel package that includes flights and hotel accommodations, the package may require the user to book flights through the company's proprietary application. The third-party application 212 may be integrated with the assignment server 302 via an API, enabling it to offer similar functionalities as the reservation application 210. Through this API integration, the third-party application 212 may enable users to book, cancel, and modify seat reservations, set seating preferences, request reassignments, and receive real-time notifications about seat availability, providing a seamless and consistent reservation experience across multiple platforms.

The networking interface 206 may enable the client computing device 202 to communicate with other devices, and/or any other suitable devices or combinations thereof. The networking interface 206 may support wired or wireless communications, such as USB, Bluetooth, Wi-Fi Direct, Near Field Communication (NFC), etc. The networking interface 206 may enable the client computing device 202 to communicate via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc. Moreover, the network may be a single communication network, or may include multiple communication networks of one or more types (e.g., one or more wired and/or PANs or LANs, and/or one or more WANs such as the Internet).

The one or more processors 204 may include any suitable number of processors and/or processor types. For example, the processors 204 may include one or more CPUs and one or more graphics processing units (GPUs). Generally, each of the processors 204 may be configured to execute software instructions stored in the corresponding one or more memories 208. The memories 208 may include one or more persistent memories (e.g., a hard drive and/or solid-state memory) and may store one or more applications, modules, and/or models, such as the reservation application 210 and the third party application 212.

Referring now to FIG. 3, the assignment server 302 can include one or more processors 304, a networking interface 306, and one or more memories 308. The memories 308 include a reservation engine 309, a qualification engine 310, a management engine 311, a detection engine 312, and an open seat engine 314. The open seat engine 314 may comprise a matching engine 314a, an assignment engine 314b, and a notification engine 314c.

The assignment server 302 may manage seat reservations for a transportation system, such as airplanes, buses, trains, and/or other passenger vehicles. The assignment server 302 may provide various seat reservation functions to a user via a user device (e.g., client computing device 202), allowing the user to interact with the assignment server 302 via the user device (e.g., through the reservation application 210 or the third-party application 212) to manage a seat reservation. For example, the assignment server 302 may present available booking options to the user, enabling the user to select a seat and submit a booking request to the assignment server 302. Similarly, the assignment server 302 may allow users to cancel or modify an existing reservation, add luggage to a booking, and perform other essential seat reservation functions.

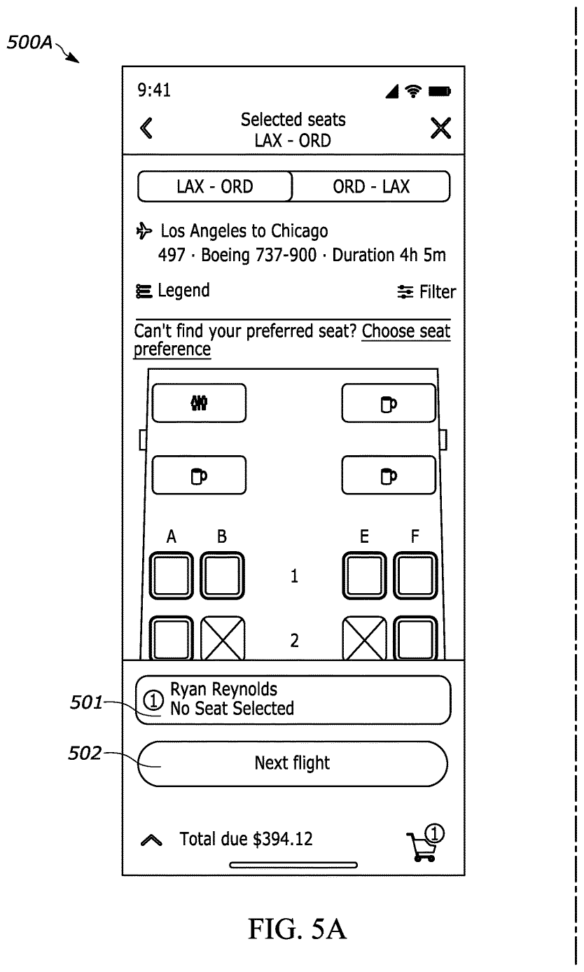

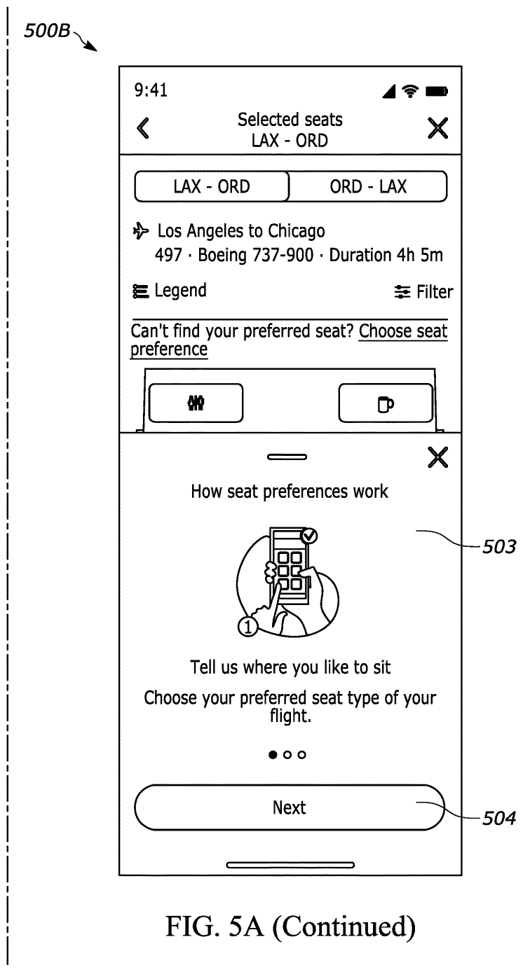

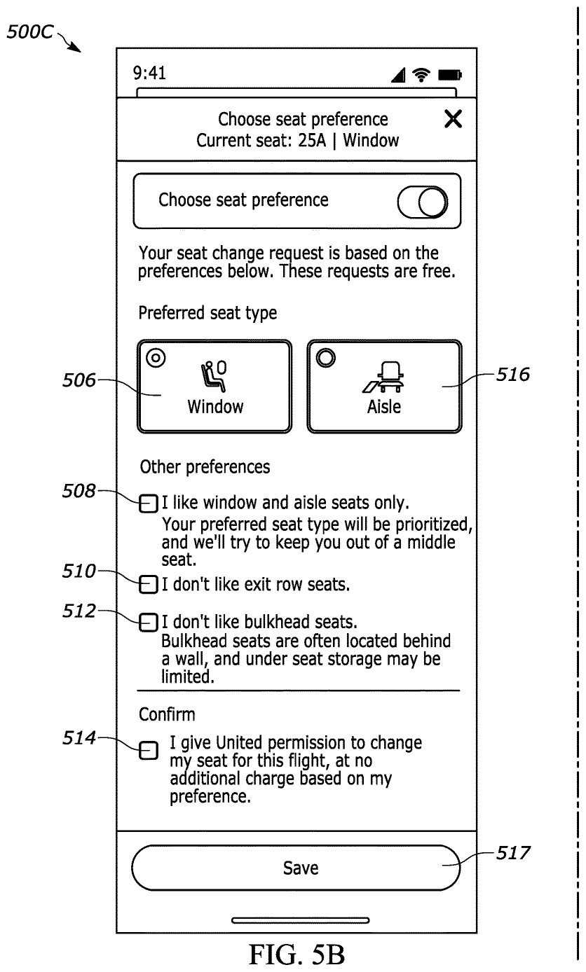

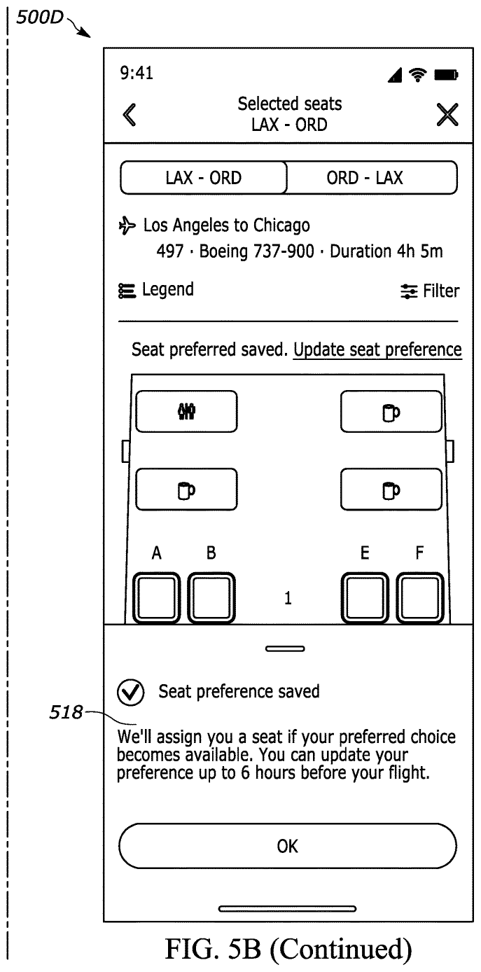

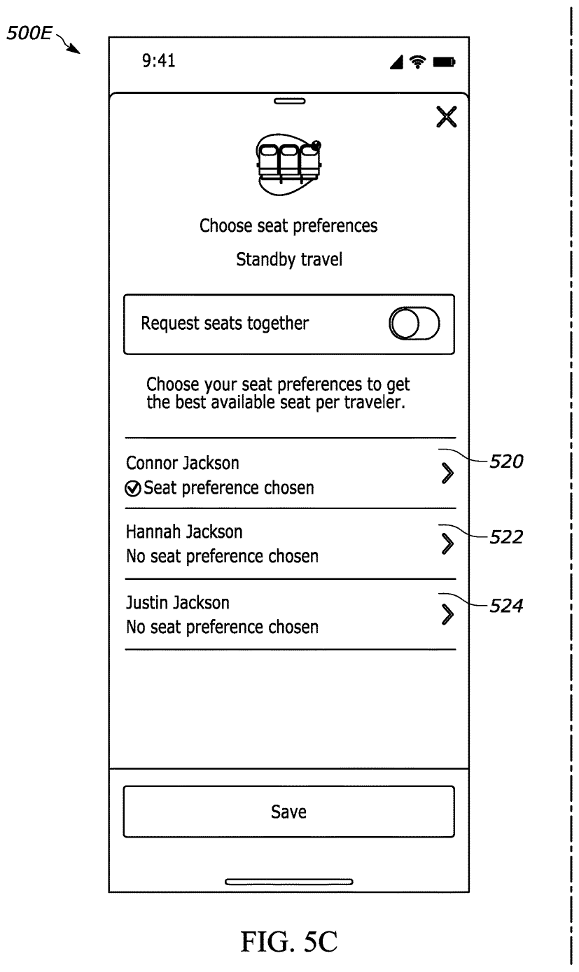

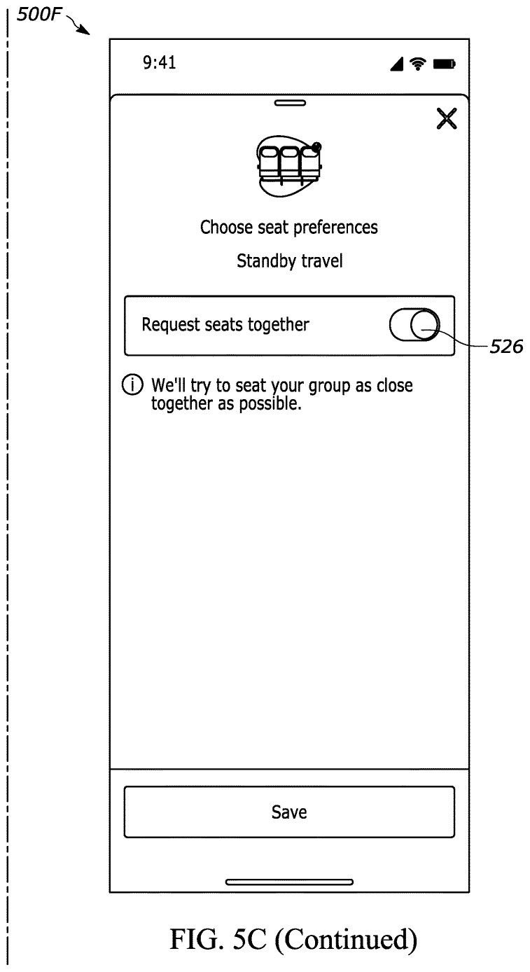

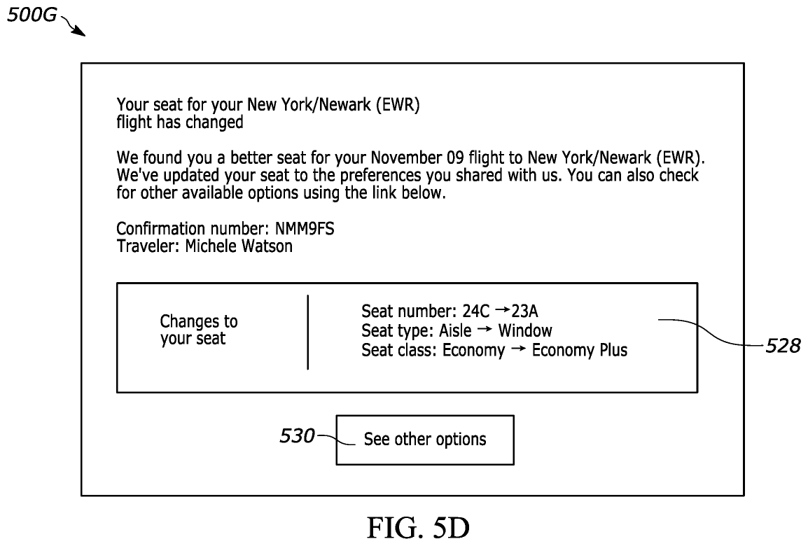

Additionally, the assignment server 302 may present a plurality of seat preference options to the user via the user device during or after the reservation process. The plurality of seat preference options may include, but not limited to, at least one of the following: a window seat, an aisle seat, a middle seat with extra legroom, adjacent seating with another user, avoidance of exit row seats, avoidance of bulkhead seats, avoidance of middle seats, or avoidance of middle seats with extra legroom. The user may submit seat preference data, specifying seating preferences among the plurality of seat preference options that the assignment server 302 can use to facilitate reassignment when an open seat matching the preference becomes available. For example, a user may prefer a window seat, but if all window seats are reserved at the time of booking, the user may submit seat preference data indicating their willingness to wait for a window seat to become available. An example of a plurality of seat preference options is illustrated in example screen 506 of FIG. 5B.

The assignment server 302 may receive a request to perform a seat reservation function (e.g., booking, canceling, modifying, etc.) from a user via a user device (e.g., client computing device 202). In some embodiments, if the user uses a third-party application (e.g., third party application 212), then the assignment server 302 may receive the request to perform the seat reservation from a third-party seat reservation server. The request may also include input data necessary to perform the request, such as user profile information, seat reservation information, vehicle information, etc. Upon receiving the request, the assignment server 302 may delegate the request to the reservation engine 309. The reservation engine 309 may be responsible for handling all standard seat reservation and management functions. The reservation engine 309 may process user requests, update reservation records, and coordinate seat assignments based on available inventory and predefined booking rules.

For instance, a user may access a flight application on a user device to book a flight for international travel. When the user submits a booking request, the request may include additional details, such as the selected flight, seat class, and optional preferences. The reservation engine 309 may retrieve relevant flight and seat availability data, finalize the booking, and confirm the reservation with the user. Similarly, if a user wishes to cancel or modify an existing reservation, the assignment server 302 may route the request to the reservation engine 309, which may update the corresponding records and notify the user of the successful transaction.

In some embodiments, the functionalities performed by the reservation engine 309 may be executed by a separate server computer and are not restricted to a specific engine within the assignment server 302. In such a scenario, the separate server computer may maintain active communication with the assignment server 302 and/or the user devices 106-116 to facilitate basic seat reservation functionalities based on input data when an open seat becomes available.

Upon receiving the seat preference data, the assignment server 302 may utilize the qualification engine 310 to verify whether the user meets necessary criteria for a seat reassignment. The qualification engine 310 may assess the input data, or may retrieve user's data stored in the database 154, including at least one of the seat preference data of the user, seat reservation data of the user, profile information of the user, or past history of the user when determining whether the user meets the qualification. For example, if the profile information of the user indicates a history of last-minute ticket cancellations, frequent no-shows, or past violations of seat assignment policies, the qualification engine 310 may reject the user's request for a seat reassignment.

If the qualification engine 310 determines that the user meets the necessary criteria for the seat reassignment, the qualification engine 310 may place the user in the assignment waitlist corresponding to their seat reservation data (e.g., seating class and travel details). The assignment waitlist may be a collection of users that signed up for a reassignment in the event of an open seat. The qualification engine 310 may maintain separate assignment waitlists for different travel instances. For example, there may be distinct assignment waitlists for different flights. In some embodiments, the qualification engine 310 may store different assignment waitlists for different cabin classes within a single travel instance. For example, there may be different assignment waitlists for first class, business class, and economy class seats within a same flight, ensuring that users are only considered for reassignment within the appropriate class of service. The assignment waitlist may be stored in the database 154.

In some embodiments, the assignment server 302 may utilize a management engine 311 to sort the assignment waitlist based on at least one of the following factors, including but not limited to: the user's seat reservation data, seat preference data, or the time at which the seat preference data was received. The management engine 311 may prioritize users dynamically to ensure optimal seat reassignment when an open seat becomes available. The management engine 311 may employ a management machine learning model that evaluates various user attributes to determine the optimal waitlist order based on historical patterns, user preferences, and system-defined prioritization criteria. Alternatively, the management engine 311 may utilize a rule-based algorithm that assigns weights to different variables within the seat reservation data, preference data, timestamp of submission, and other relevant user data to systematically define the order in which users are considered for reassignment.

For example, the management engine 311 may prioritize a user who is an elderly passenger with a disability over another user who, despite having booked the flight earlier and thus having an earlier timestamp for their preference data, may be ranked lower in the assignment waitlist. The management engine 311 may evaluate multiple factors beyond booking time to ensure that seat reassignment decisions are made in a manner that optimally accommodates passenger needs and enhances overall fairness in seat allocation.

The assignment server 302 may utilize a detection engine 312 to identify when an open seat event occurs, indicating the availability of a previously occupied or unassigned seat. The open seat event may be triggered by various factors, including a seat cancellation, an upgrade where a passenger moves to a higher-class seat, or an operational seat adjustment due to external factors such as maintenance, safety compliance, or changes in aircraft configuration. In some embodiments, the detection engine 312 may operate as a separate server computer that continuously monitors seat availability across the transportation system. Upon detecting an open seat event, the detection engine 312 may generate a notification and transmit it to the assignment server 302, enabling real-time updates for seat reassignment processing. In certain implementations, the separate server hosting the detection engine 312 may also house the reservation engine 309, facilitating seamless coordination between seat reservation functions and dynamic seat reassignment operations. In some other embodiments, the detection engine may be hosted by a dedicated seat reservation server such as an internal seat reservation server or a third-party seat reservation server, and the assignment server 302 may receive an open seat event from the dedicated seat reservation server. For instance, the user may cancel a reservation via a third party application 212 rather than the reservation application 210.

The assignment server 302 upon detecting or receiving the open seat event indicating availability of an open seat, may utilize the open seat engine 314 to retrieve an assignment waitlist related to the open seat event. For instance, the open seat event may comprise vehicle information and seating information including cabin class, seat number, window seat, etc. that allows the assignment server 302 to obtain an assignment waitlist that matches with the open seat. The open seat engine 314 may then utilize the matching engine 314a to select a specific user from the assignment waitlist that matches with the open seat specification. For instance, the matching engine 314a may select one or more users with a seat reservation of the particular cabin class from the assignment waitlist and select a designated user from the assignment waitlist based on one or more seat preference data of the one or more users with the seat reservation of the particular cabin class.

The matching engine 314a may utilize a matching machine learning model to select a user for seat reassignment or may employ a predefined algorithm that accounts for various scenarios when determining the appropriate user. For instance, if the assignment waitlist has been sorted based on priority by the management engine 311, the matching engine 314a may select the highest-ranked user whose seat preference data aligns with the open seat event criteria. The matching machine learning model may evaluate all relevant scenarios to determine the optimal user for reassignment, balancing multiple factors to enhance passenger satisfaction and overall seat allocation efficiency. For example, if the assignment server detects or receives multiple open seat events for adjacent seats in close succession, the matching engine 314a may prioritize users who have indicated a preference to sit together. This ensures that users who have requested adjacent seating are assigned seats accordingly rather than being reassigned separately due to independent seat openings.

In some embodiments, the matching engine 314a may re-sort unassigned passengers to provide users with seats that align with their user preference data. For example, in basic economy seating, passengers may not receive their seat assignments until the day of the flight. In such a scenario, the matching engine 314a may dynamically reassign and adjust seating arrangements to accommodate high-priority users at the top of the waitlist, ensuring that passengers who wish to sit together are accommodated whenever possible.

In some embodiments, the matching engine 314a may provide users with additional seating options beyond simply matching them to the first available open seat. For example, if multiple open seats become available in close succession, the matching engine 314a may initially match the user with the first suitable seat while also presenting alternative backup options before those seats are assigned to other users.

Upon identifying a user for the open seat event, the assignment server 302 may utilize the assignment engine 314b to finalize the seat reassignment. The assignment engine 314b may update the seat assignment records with the user's information, modify the seating configuration of the flight, and perform any necessary adjustments to the reservation, such as recalculating the seat price if applicable. For instance, if the reassigned seat is located closer to the entrance or offers additional legroom, the system may determine that the newly assigned seat requires an additional charge compared to the user's originally booked seat. The assignment server 302 may, upon assigning the user, may update the assignment waitlist by removing the designated user. The assignment server 302, upon completing the seat reassignment, may invoke the notification engine 314c to transmit a notification to the user via the user device, informing them of the newly assigned seat and any changes to their reservation. In some embodiments, the notification engine 314C may transmit the notification of the assignment to the user device via the third party application.

In some embodiments, before finalizing the seat reassignment, the assignment server 302 may utilize the notification engine 314c to send a confirmation request to the user, prompting them to accept the reassignment to the open seat. The notification may include details about the open seat, a price change confirmation indicating a price change for the assignment to the open seat, and/or other relevant. The notification engine 314C may impose a predetermined time limit for the user to respond to the reassignment offer. In some instances, the notification may also include a selection to see possible other options that the user may select. If the user accepts the reassignment, the assignment server 302 may proceed with the seat assignment using the assignment engine 314b and update the reservation accordingly. If the user rejects the reassignment or fails to respond within the designated time frame, the assignment server 302 may treat the request as declined. In such a case, the matching engine 314a may initiate a new selection process to identify another user from the assignment waitlist who meets the criteria for the open seat event, ensuring that the seat is efficiently reassigned.

The networking interface 106 may enable the assignment server 302 to communicate with other devices, and/or any other suitable devices or combinations thereof. The networking interface 306 may support wired or wireless communications, such as USB, Bluetooth, Wi-Fi Direct, Near Field Communication (NFC), etc. The networking interface 306 may enable the assignment server 302 to communicate via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc. Moreover, the network may be a single communication network or may include multiple communication networks of one or more types (e.g., one or more wired and/or PANs or LANs, and/or one or more WANs such as the Internet).

More generally, the one or more processors 304 may include any suitable number of processors and/or processor types. For example, the processors 304 may include one or more CPUs and one or more graphics processing units (GPUs). Generally, each of the processors 304 may be configured to execute software instructions stored in the corresponding one or more memories 308. The memories 308 may include one or more persistent memories (e.g., a hard drive and/or solid-state memory) and may store one or more applications, modules, and/or models, such as the qualification engine 310, the management engine 311, the detection engine 312, etc.

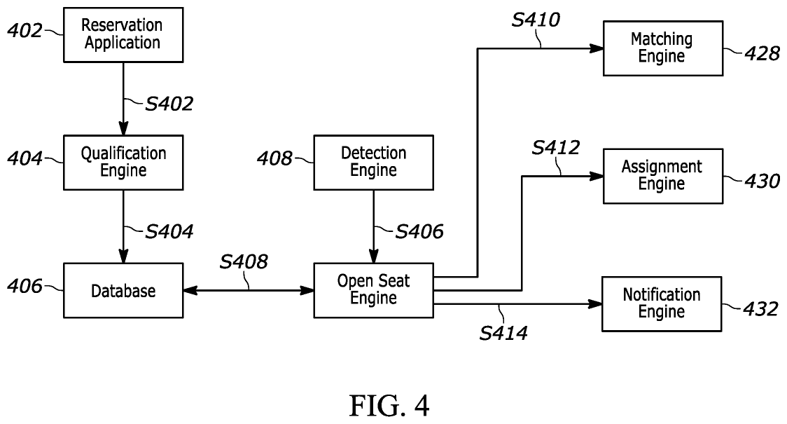

FIG. 4 illustrates a block and logic diagram for assigning a user to an open seat in a seat assignment system (e.g., seat assignment system 100 of FIG. 1). A reservation application 402 may correspond to a reservation application 210 of FIG. 2, a qualification engine 404 may correspond to a qualification engine 310 of FIG. 3, a database 406 may correspond to a database 154 of FIG. 1, a detection engine 408 may correspond to a detection engine 312 of FIG. 3, an open seat engine 416 may correspond to an open seat engine 314 of FIG. 3, a matching engine 428 may correspond to a matching engine 314a of FIG. 3, an assignment engine 430 may correspond to an assignment engine 314b of FIG. 3, and a notification engine 432 may correspond to a notification engine of FIG. 3. The seat assignment system may assign a user to an open seat only until a predetermined time period before departure. For example, the assignment may only be available until 2 hours before flight takeoff.

A user may utilize the client computing device 402 to reserve a seat assignment through a reservation application 402. For example, when booking a seat for a flight, the user may find that their preferred seat type is unavailable. If all window seats have already been reserved by other passengers, the reservation application 402 may present the user with a plurality of seat preference options during the checkout process of the seat assignment. These seat preference options may include, but are not limited to, a window seat, an aisle seat, a middle seat with extra legroom, adjacent seating with another user, avoidance of exit row seats, avoidance of bulkhead seats, avoidance of middle seats, or avoidance of middle seats with extra legroom. In some embodiments, instead of providing seat preference options at checkout, the reservation application 402 may offer them after the seat reservation is confirmed, allowing users to specify preferences for future reassignments without delaying the initial booking process.

In step S402, upon receiving the plurality of seat preference options, the user may select their preferred options and submit seat preference data to an assignment server (e.g., assignment server 302) via a user device (e.g., client computing device 202) hosting the reservation application 402. The assignment server may store and use the seat preference data to facilitate automatic seat reassignment when a matching open seat becomes available. The user may also update their seat preference data as needed until a predetermined cutoff time before departure. For example, the system may restrict changes to seat preference data within two hours of flight takeoff, ensuring sufficient time for processing reassignments. Along with the seat preference data, the reservation application 402 may transmit the user profile information, including age, sex, past booking history, loyalty status, and disability accommodations, as well as seat reservation information, including vehicle details, available seats, departure and arrival times, transportation type (e.g., flight, train, bus), cabin class information, price, seat assignment history, and any special requests associated with the reservation to the assignment server.

In step S404, the assignment server 302, upon receiving the seat preference data, user profile information, and seat reservation information from the reservation application 402, may apply the qualification engine 404 to determine whether the user meets the necessary criteria for seat reassignment. The qualification engine 404 may assess various factors, including the user's seat preference data, current seat reservation details, user profile information, reservation history, and other relevant attributes to determine whether the user qualifies for reassignment. For instance, if the user profile indicates that the user has a history of repeatedly modifying their seat preference data within a single booking or has previously violated seat assignment policies, the qualification engine 404 may reject the user's request for seat preference reassignment. In some embodiments, if too many users have already submitted similar seat preference requests before the user, the qualification engine 404 may reject the request, notifying the user that they may either need to update their seat preference data with alternative options or that reassignment based on their current preferences is unavailable.

If the qualification engine 404 determines that the user meets the required criteria, it may store the seat preference data to the corresponding assignment waitlist based on the seat reservation information. For example, the qualification engine 404 may add the user to an assignment waitlist corresponding to the travel instance (e.g., specific flight) of the open seat in the database 406. In some embodiments, the assignment server 302 may utilize a management engine to sort the assignment waitlist based on factors such as user profile data, seat reservation data, seat preference data, or the timestamp when the user submitted their seat preference data. For example, a passenger with a disability may be prioritized higher in the assignment waitlist over a regular passenger when requesting extra legroom seating. The qualification engine 404 may continuously update the corresponding assignment waitlist and store it in the database 406.

In step S406, the detection engine 408 may monitor seat availability and detect an open seat event when a seat becomes available. Upon detecting such an event, the detection engine 408 may notify the open seat engine 416, which may be responsible for processing reassignment requests. The open seat event may be triggered by various actions, including seat cancellations, seat modifications, passenger upgrades, operational seat changes, or system adjustments due to external factors (e.g., aircraft configuration changes or maintenance).

In step S408, upon receiving the open seat event notification, the open seat engine 416 may retrieve the corresponding assignment waitlist from the database 406 to determine which users are eligible for reassignment. The open seat engine 416 may utilize travel-specific information, such as the flight number, train number, or other uniquely identifiable transportation ID, to fetch the relevant assignment waitlist from the database 406.

In step S410, upon retrieving the assignment waitlist, the matching engine 428 may identify a user whose seat preference data aligns with the open seat event. The matching engine 428 may filter users from the assignment waitlist based on the open seat specifications to ensure that reassignment decisions adhere to user preferences. For instance, if the open seat is a window seat, the matching engine 428 may select users from the assignment waitlist who have indicated a preference for a window seat. After filtering users who meet the basic preference criteria, the matching engine 428 may employ a machine learning model or a predefined algorithm to select the most suitable user for reassignment. In one scenario, the matching engine 428 may prioritize the top-ranking user from the assignment waitlist whose preference matches the open seat type. Alternatively, the matching engine 428 may analyze additional factors by feeding a machine learning model with current seat assignments, available seats, and assignment waitlist data to determine the optimal user for reassignment. For example, even if the open seat is an aisle seat at the back of the airplane, the machine learning model may recognize that assigning an elderly passenger at the top of the waitlist to this seat may not be optimal due to accessibility concerns. Instead, the machine learning model may identify another user who is better suited for that seat based on travel preferences and user profile data.

In step S412, after the matching engine 428 selected a designated user for the open seat, the assignment engine 430 may update seat assignment records, modify the seating configuration of the vehicle, and apply necessary adjustments to the user's reservation. For example, if the reassigned seat offers additional legroom, the assignment engine 430 may determine that the newly assigned seat requires an additional charge compared to the user's originally booked seat. The system may adjust the pricing structure accordingly and ensure that the reassignment complies with fare rules and booking policies. The assignment engine 430 may also update the assignment waitlist by removing the designated user. In step S414, upon completing the reassignment, the notification engine 432 may notify the user via the reservation application 402, providing details of the new seat assignment and any changes to their reservation, including pricing updates if applicable.

In some embodiments, before finalizing the seat reassignment, the notification engine 432 may send a confirmation request to the user via the reservation application 402. The notification may include details about the open seat, any associated changes to the reservation, and additional charges, if applicable. The notification engine 432 may impose a predetermined time limit for the user to accept or decline the reassignment offer. If the user accepts the reassignment, the assignment engine 430 may proceed with finalizing the seat assignment and updating the reservation records. If the user rejects the reassignment offer or fails to respond within the time limit, the open seat engine 416 may instruct the matching engine 428 to identify another user from the assignment waitlist who meets the open seat criteria. The system may then reassign the seat to the next most suitable user, ensuring that the seat reassignment process continues efficiently until a final match is confirmed.

FIGS. 5A-5D illustrate example user interfaces within a reservation application that a user may navigate to select seat preferences, according to some embodiments. The user may begin by booking a seat for a flight. In FIG. 5A, while selecting a seat during the booking process, the user may find that no preferred seats are available in display 500A and may choose not to select any seat, as indicated by notification 501. The user may then proceed with the booking by clicking button 502, which renders display 500B. Display 500B may present manual 503, explaining how the seat preference selection process works. The reservation application may provide this option upon detecting that the user has not selected a seat in display 500A. After reading the manual, the user may click button 504 to proceed to the next step, where they can select seat preferences from a list of available options.

In FIG. 5B, display 500C may present the user with a plurality of seat preference options, including window seat option 506, aisle seat option 516, avoidance of middle seats option (i.e., selecting only window and aisle seats) 508, avoidance of exit row seats option 510, and avoidance of bulkhead seats option 512. The user may select one or more options from the available seat preference choices, check permission option 514, and then confirm the selection by clicking button 517, which advances to display 500D. Display 500D may notify the user that the seat preference data has been successfully saved based on their selected options from the plurality of seat preference options.

In FIG. 5C, display 500E may provide the user with an option to specify other passengers with whom they prefer to sit adjacent on the same flight. The user may select multiple passengers from the flight manifest, including a passenger 520, a passenger 522, and a passenger 524. After making these selections, the user may enable the option 526 in display 500F to formally request to be seated together with the selected passengers. In FIG. 5D, when an open seat event occurs and the user gets successfully matched to the open seat, the user may receive a notification in display 500, informing them of the seat reassignment. The notification may include seat reassignment details 528, and the user may explore additional options by pressing button 530. The additional options may include an option for the user to reject the open seat and/or re-update the seat preference data.

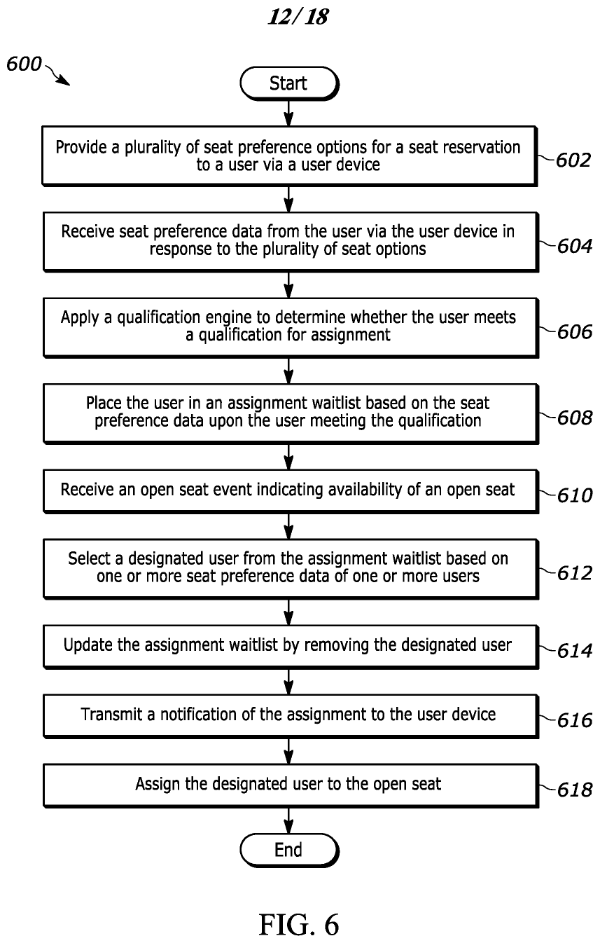

FIG. 6 illustrates an example method 600 for assigning a user to an open seat for a seat reservation. The method can be implemented in a set of instructions stored on a computer-readable memory and executable at one or more processors of an assignment server 302 of FIG. 3.

At block 602, the one or more processors may provide a plurality of seat preference options for a seat reservation to a user via a user device. The plurality of seat preference options may include at least one of: a window seat, an aisle seat, a middle seat with extra legroom, adjacent seats with another user, avoidance of exit row seats, avoidance of bulkhead seats, avoidance of middle seats, or avoidance of middle seats with extra legroom. In some embodiments, the one or more processors may provide the plurality of seat preference options after the seat reservation is confirmed. In another embodiments, the one or more processors may provide the plurality of seat preference options during checkout of the seat reservation.

At block 604, the one or more processors may receive seat preference data from the user via the user device in response to the plurality of seat preference options. In some embodiments, the one or more processors may receive the open seat event from a dedicated seat reservation server, such as an internal seat reservation server or a third-party seat reservation server.

At block 606, the one or more processors may apply a qualification engine to determine whether the user meets a qualification for assignment. The qualification engine may determine whether the user meets the qualification for the assignment based on at least one: the seat preference data of the user, seat reservation data of the user, profile information of the user, or past history of the user.

At block 608, the one or more processors may place the user in an assignment waitlist based on the seat preference data upon the user meeting the qualification. The assignment waitlist may be based on at least one of: seat reservation data of the user, the seat preference data of the user, or a time in which the seat preference data of the user has been received

At block 610, the one or more processors may receive an open seat event indicating availability of an open seat. The open seat event may be generated based on at least one of: a seat cancellation of the open seat, an upgrade of the open seat to another seat, or an operational seat assignment.

At block 612, the one or more processors may select a designated user from the assignment waitlist based on one or more seat preference data of one or more users. The designated user may be the user. In some embodiments, the open seat may be classified into a particular cabin class among different cabin classes. The one or more processors may select one or more users with a seat reservation of the particular cabin class and select the designated user from the assignment waitlist based on one or more seat preference data of the one or more users with the seat reservation of the particular cabin class.

At block 614, the one or more processors may update the assignment waitlist by removing the designated user. In some embodiments, the one or more processors may update the user in the assignment waitlist based on the updated seat preference data upon the user meeting the qualification.

At block 616, the one or more processors may transmit a notification of the assignment to the user device. In some embodiments, the one or more processors may transmit the notification of the assignment to the user device, where that notification may be transmitted internally between applications of carrier computing platform/reservation server, via a third-party platform hosted by a third-party seat reservation server, and through other electronic communication pathways.

At block 618, the one or more processors may assign the designated user to the open seat, wherein the open seat matches at least a portion of the seat preference data from the designated user. The assigning the designated user to the open seat is performed until a predetermined time period prior to a flight takeoff.

In some embodiments, the notification of the assignment may comprise a request for the user to accept the assignment to the open seat. The one or more processors may then receive a response from the user indicating acceptance of the assignment in response to the request to accept the assignment to the open seat. The request for the user to accept the assignment may further comprise a price change confirmation indicating a price change for the assignment to the open seat. The request for the user to accept the assignment to the open seat may include a predetermined time limit for accepting the request.

### Further Example Seat Reservation Systems and Associated Seat Reassignment Processes

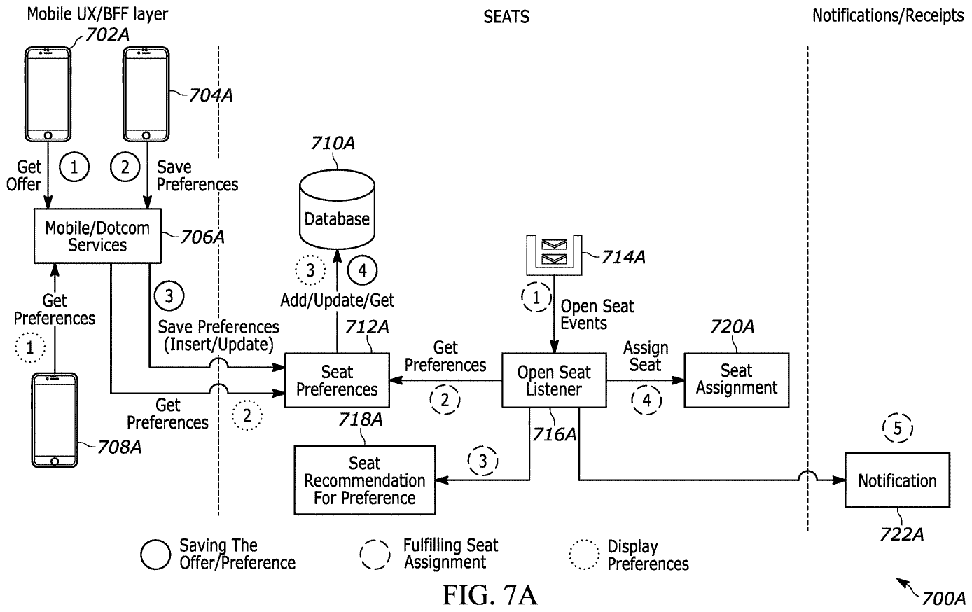

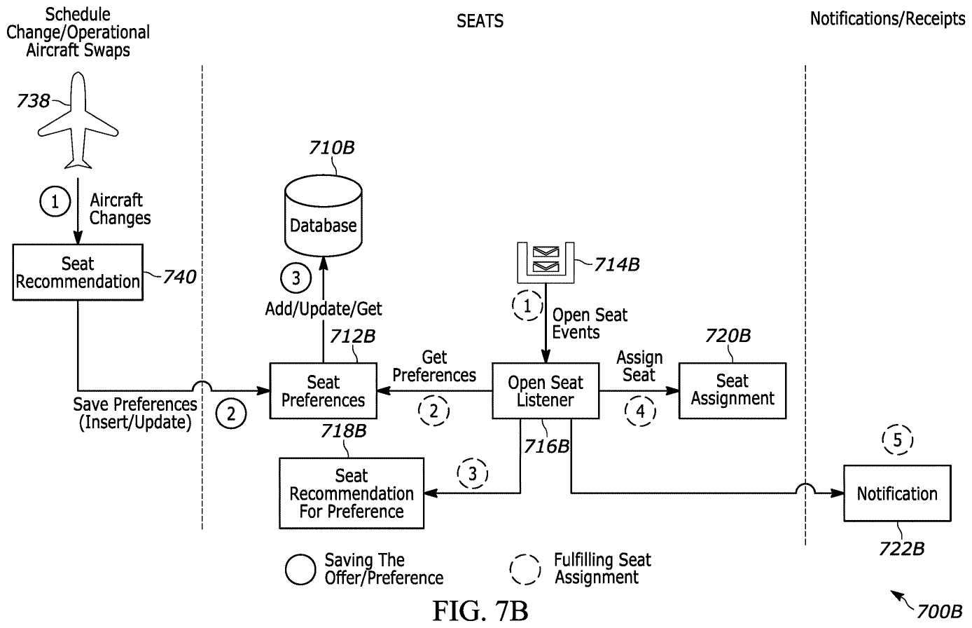

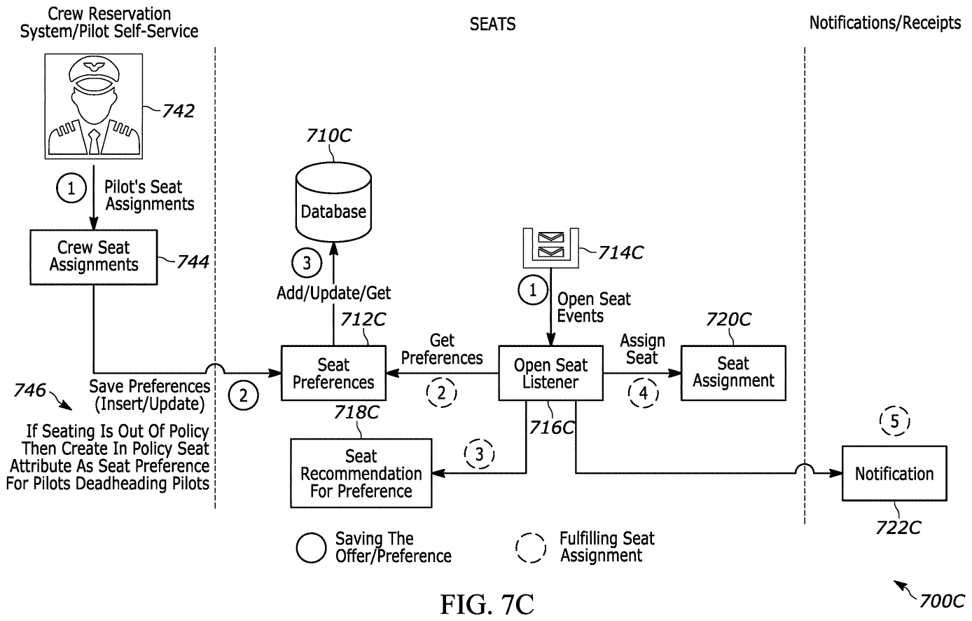

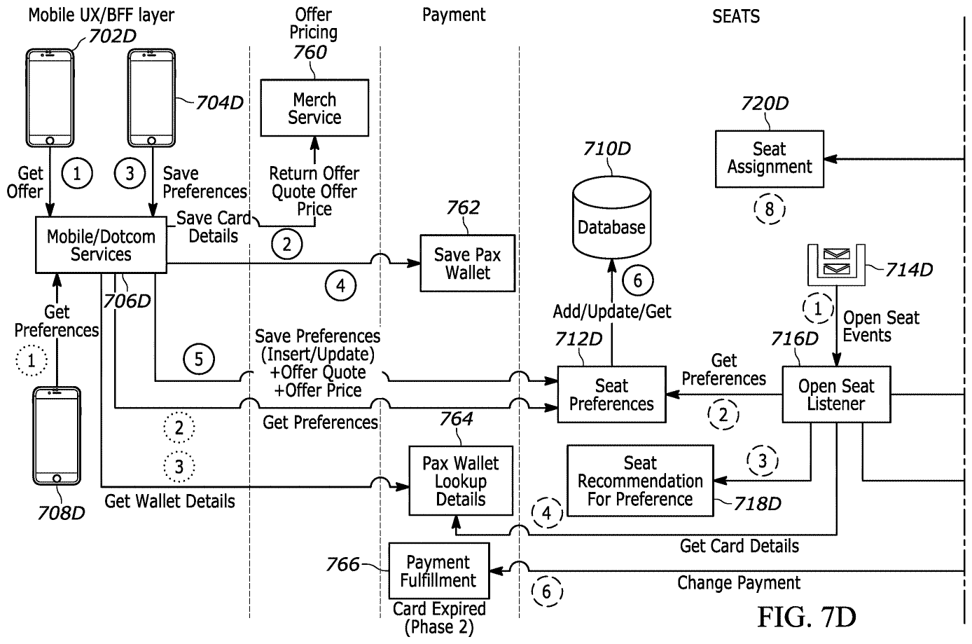

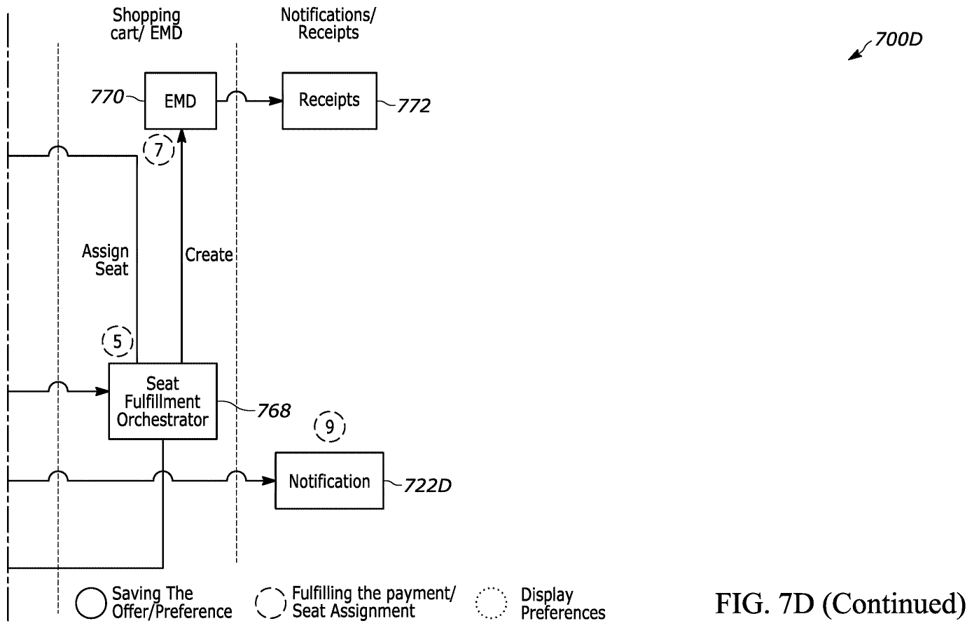

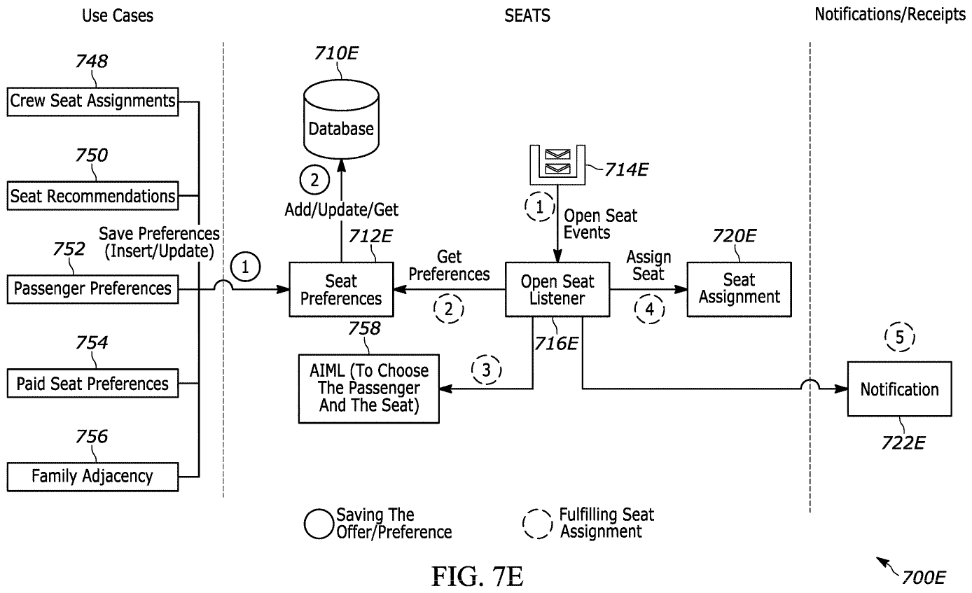

Referring now to FIG. 7A, a seat preferences system 700A illustrates an additional example seat reservation system and associated seat reassignment process for automated seat preference management. The seat preferences system 700A depicts an alternative implementation of the seat assignment functionality described with reference to FIGS. 1-6, including the comprehensive seat assignment system 100 and the assignment server 302. As described previously, the comprehensive seat assignment system 100 and the assignment server 302 may include one or more processors and one or more non-transitory, computer-readable media storing instructions that, when executed by the one or more processors, cause the seat reservation system to perform various seat assignment operations. FIGS. 7A-7E depict various use cases for automated seat preference management, each illustrating different scenarios in which the seat assignment functionality may be applied to accommodate passenger preferences, operational changes, crew seating requirements, paid seat preferences, and family adjacency requests.

With continued reference to FIG. 7A, the seat preferences system 700A includes a Mobile UX/BFF layer that facilitates user interactions with the seat reservation system. The Mobile UX/BFF layer includes a first mobile device 702A, a second mobile device 704A, and a third mobile device 708A, which may be associated with different passengers and may enable users to perform various seat preference operations. In some embodiments, a mobile device may facilitate a get offer operation, allowing users to retrieve available seat preference options for a scheduled flight. A mobile device may also facilitate a save preferences operation, enabling users to submit seat preference data to the seat reservation system. Additionally, a mobile device may facilitate get preferences operations, allowing users to retrieve previously stored seat preference data. These functions are provided as examples and may be performed by any of the mobile devices associated with different passengers. The system may support any number of mobile devices and is not limited to the configuration shown in FIG. 7A. The Mobile UX/BFF layer further includes a Mobile/Dotcom services component 706A that receives and processes user interactions from the mobile devices. The Mobile/Dotcom services component 706A may transmit a save preferences operation to the seats system for storage and processing.

The seat preferences system 700A includes a seats system that performs seat assignment operations similar to those described with respect to the assignment server 302 of FIG. 3. The seats system includes a database 710A that may correspond to the database 154 described with respect to FIG. 1. The database 710A may perform add, update, and get operations for storing and retrieving seat preference data, assignment waitlist information, and seat assignment records. A seat preferences component 712A receives saved preferences from the Mobile/Dotcom services component 706A and interfaces with the database 710A to store and manage seat preference data for passengers on a scheduled flight.

The seats system further includes an open seat events component 714A that monitors seat availability and detects open seat events indicating availability of a new open seat for a scheduled flight. The open seat events component 714A may generate open seat event notifications based on at least one of: a seat cancellation of the new open seat, an upgrade of the new open seat to another seat, or an operational seat assignment. An open seat listener 716A receives notifications from the open seat events component 714A and coordinates the seat reassignment process. Upon detecting an open seat event, the seat reservation system may suspend manual seat change requests in response to detecting the open seat event, ensuring that the automated seat reassignment process proceeds without interference from concurrent manual modifications.

The open seat listener 716A retrieves preferences from the seat preferences component 712A and interfaces with a seat recommendation for preference component 718A. The seat recommendation for preference component 718A may generate seat recommendations based on the retrieved seat preference data and available open seats. The seat recommendation for preference component 718A may function similarly to the matching engine 314a described with respect to FIG. 3, evaluating seat preference data to identify passengers whose preferences align with available open seats.

The seat preferences system 700A may generate a final seat reassignment plan for the scheduled flight. The final seat reassignment plan fills the new open seat and one or more subsequently opened seats from passengers included on an assignment waitlist using seat preference data for each passenger included on the assignment waitlist. The one or more subsequently opened seats include seats opened in response to filling of the new open seat with a passenger from the assignment waitlist. For example, when a passenger from the assignment waitlist is reassigned to the new open seat, the seat previously occupied by that passenger becomes a subsequently opened seat that may be filled by another passenger from the assignment waitlist.

To generate the final seat reassignment plan, the seat reservation system may generate a plurality of seat reassignment plans for the scheduled flight. Each of the plurality of seat reassignment plans differently fills the new open seat and subsequently opened seats from passengers included on the assignment waitlist using the seat preference data. The seat reservation system may select the final seat reassignment plan from the plurality of seat reassignment plans, wherein the final seat reassignment plan best satisfies plan selection criteria as compared to other ones of the plurality of seat reassignment plans. To select the final seat reassignment plan, the seat reservation system may rank the plurality of seat reassignment plans based on a degree to which each of the plurality of seat reassignment plans satisfies the plan selection criteria and select a highest ranked one of the plurality of seat reassignment plans as the final seat reassignment plan.

The assignment waitlist includes a ranking of the passengers that is based on at least one of: seat reservation data of the passengers, the seat preference data, passenger status data, or times at which the seat preference data was received. In some embodiments, the passenger status data may include passenger or user profile information, such as age, disability status, past seating history, frequent travel routes, and loyalty program status, as described elsewhere herein. The management engine 311 described with respect to FIG. 3 may generate and maintain the assignment waitlist ranking based on these factors. The seat preference data includes one or more ranked preferences per passenger. For example, a passenger may specify a window seat preference as a first ranked preference and an aisle seat preference as a second ranked preference. The seat preference data may include at least one of: a window seat preference, an aisle seat preference, a middle seat with extra legroom preference, preference for adjacent seats with another passenger, avoidance of exit row seats, avoidance of bulkhead seats, avoidance of middle seats, or avoidance of middle seats with extra legroom.

The plan selection criteria includes one of: maximizing total passengers removed from the seat assignment waitlist, maximizing a number of highest ranked passengers removed from the seat assignment waitlist, maximizing a number of adjacent seating requests from the seat assignment waitlist that are fulfilled, or maximizing a total number of highest ranked preferences fulfilled. The seat reservation system may evaluate each of the plurality of seat reassignment plans against the plan selection criteria to determine which plan provides the optimal outcome for passengers on the assignment waitlist.

To generate the final seat reassignment plan, the seat reservation system may determine, via a qualification engine, whether a passenger on the assignment waitlist meets qualifications for the new open seat and subsequently opened seats based on at least one of: the seat preference data, seat reservation data for the passengers, profile information of the passengers, or past history of the passengers. The qualification engine 310 described with respect to FIG. 3 may perform this qualification determination. When the new open seat is classified into a particular cabin class among different cabin classes, the seat reservation system may determine the passengers on the assignment waitlist eligible for the new open seat based on one or more of the particular cabin class, the seat preference data, and profile information of the passengers. The seat reservation system may assign a passenger from the assignment waitlist that is eligible to sit in the cabin class of the new open seat to the new open seat in the final seat reassignment plan.

A seat assignment component 720A finalizes seat assignments based on the final seat reassignment plan. The seat assignment component 720A may update seat assignment records and modify seating configurations for the scheduled flight. The seat reservation system may update the assignment waitlist to remove reassigned passengers moved to the new open seat and subsequently opened seats in the final seat reassignment plan. In some embodiments, the seat reservation system may retain, on the assignment waitlist, reassigned passengers for which a reassigned seat in the final seat reassignment plan fails to meet a respective highest ranked preference. This allows passengers who received a lower-ranked preference to remain eligible for future reassignment if a seat matching their highest ranked preference becomes available.

A notification component 722A receives information from the seat assignment component 720A and transmits one or more notifications of new seat assignments from the final seat reassignment plan to user devices associated with the reassigned passengers. The notification component 722A may function similarly to the notification engine 314c described with respect to FIG. 3. Upon completing the seat reassignment process and selecting the final seat reassignment plan, the seat reservation system may reenable the manual seat change requests in response to selecting the final seat reassignment plan, allowing passengers to resume manual seat modifications.

The seat reservation system may provide a plurality of seat preference options for a seat reservation to passengers via user devices associated with passengers for the scheduled flight. The seat reservation system may compile the seat preference data based on selections of the plurality of seat preference options via the user devices. The seat reservation system may stop detecting future open seat events within a predetermined time period prior to a set takeoff time of the scheduled flight, ensuring that seat assignments are finalized before departure.

Referring now to FIG. 7B, a seat preferences system 700B illustrates an alternative or complimentary embodiment to the seat preferences system 700A of FIG. 7A, specifically configured for handling passenger seat changes triggered by aircraft type changes or operational aircraft swaps. The seat preferences system 700B addresses scenarios where aircraft configuration changes necessitate automatic seat reassignment, such as when an airline substitutes one aircraft type for another on a scheduled flight due to maintenance requirements, operational adjustments, or fleet availability changes.

The seat preferences system 700B includes a Schedule change/Operational Aircraft changes component 738 that initiates the seat reassignment process in response to aircraft changes. the aircraft changes component 738 detects when an aircraft type change or swap occurs for a scheduled flight. The aircraft changes component 738 may receive notifications from airline operations systems indicating that the originally scheduled aircraft has been replaced with a different aircraft type having a different seating configuration. Upon detecting an aircraft change, the aircraft changes component 738 triggers a seat reaccommodation component 740, which initiates the process of saving preferences and managing seat reassignments for affected passengers.

The seat reaccommodation component 740 may automatically add passengers to an assignment waitlist based on their original seat preferences and original seat selection when their aircraft changes. Unlike the user-initiated preference scenarios of FIG. 7A where passengers actively submit seat preference data through mobile devices, the seat preferences system 700B generates seat preference data based on the passengers' original seat assignments and any previously stored preferences. For example, if a passenger was originally assigned a window seat in row 12 on the first aircraft, the seat reaccommodation component 740 may generate seat preference data indicating a window seat preference for that passenger on the replacement aircraft. The seat reaccommodation component 740 transmits a save preferences operation to the seats system for storage and processing.

With continued reference to FIG. 7B, the seats system of the seat preferences system 700B includes components that are substantially similar to their corresponding components described with reference to FIG. 7A. A database 710B may perform add, update, and get operations for storing and retrieving seat preference data, assignment waitlist information, and seat assignment records in a manner similar to the database 710A. A seat preferences component 712B receives saved preferences from the seat reaccommodation component 740 and interfaces with the database 710B to store and manage seat preference data for passengers affected by the aircraft change.

An open seat events component 714B monitors seat availability and detects open seat events for the replacement aircraft. In the context of aircraft changes, the open seat event may be generated based on operational seat assignments when aircraft configurations change, rather than based on individual seat cancellations or upgrades as in the passenger preference scenarios of FIG. 7A. When an aircraft swap occurs, the entire seating configuration may change, potentially creating multiple open seats that differ from the original aircraft layout. The open seat events component 714B may generate open seat event notifications reflecting the available seats on the replacement aircraft.

An open seat listener 716B receives notifications from the open seat events component 714B and coordinates the seat reassignment process for passengers affected by the aircraft change. The open seat listener 716B retrieves preferences from the seat preferences component 712B and interfaces with a seat recommendation for preference component 718B. The seat recommendation for preference component 718B may generate seat recommendations based on the retrieved seat preference data and available seats on the replacement aircraft.

In the context of aircraft swaps, the seat reservation system may generate seat reassignment plans that prioritize maintaining similar seat attributes to the passengers' original assignments. The plan selection criteria for aircraft change scenarios may include maximizing the number of passengers who receive seats with attributes similar to their original seats, such as maintaining window or aisle positions, preserving proximity to the front or rear of the cabin, or retaining extra legroom assignments where available on the replacement aircraft. The seat reservation system may evaluate each of a plurality of seat reassignment plans against these criteria to determine which plan provides outcomes that minimize disruption to passengers affected by the aircraft change.

A seat assignment component 720B finalizes seat assignments based on the final seat reassignment plan generated for the aircraft change scenario. The seat assignment component 720B may update seat assignment records and modify seating configurations for the scheduled flight on the replacement aircraft. A notification component 722B receives information from the seat assignment component 720B and transmits notifications of new seat assignments to user devices associated with passengers affected by the aircraft change. The notification component 722B may inform passengers that their seat assignments have changed due to an aircraft swap and provide details of their new seat assignments on the replacement aircraft.

Referring now to FIG. 7C, a seat preferences system 700C illustrates an alternative or complimentary embodiment to the seat preferences system 700A of FIG. 7A and the seat preferences system 700B of FIG. 7B, specifically configured for handling crew seat assignments as distinguished from passenger assignments. The seat preferences system 700C addresses scenarios where deadheading pilots or other crew members require seat assignments on scheduled flights, and where airline policies dictate specific seating requirements for crew members based on operational and regulatory considerations.

The seat preferences system 700C includes a Crew reservation system/Pilot self-service interface 742 that initiates the seat assignment process for crew members. The pilot interface 742 enables pilots and other crew members to interact with the seat reservation system and initiate pilot seat assignments. The pilot interface 742 may receive seat assignment requests from crew members who are traveling as passengers on scheduled flights, commonly referred to as deadheading. Unlike the passenger-focused embodiments of FIGS. 7A and 7B where passengers actively submit seat preference data through mobile devices, the seat preferences system 700C processes crew seat assignments based on airline policies and crew-specific requirements.

A crew seat assignments component 744 receives seat assignment information from the pilot interface 742 and manages the crew seat assignment process. The crew seat assignments component 744 may maintain records of crew members requiring seat assignments on scheduled flights and may coordinate with airline operations systems to ensure that crew seating requirements are met. The crew seat assignments component 744 passes seat assignment data to an out-of-policy conditional logic 746 for policy compliance evaluation.

The out-of-policy conditional logic 746 implements qualification engine functionality to determine whether crew seating is out of policy and creates in-policy seat attributes as seat preferences for deadheading pilots. The out-of-policy conditional logic 746 may evaluate crew seat assignments against airline policies that specify seating requirements for crew members, such as requirements for crew members to be seated in specific cabin classes, in proximity to emergency exits, or in seats that meet regulatory requirements for crew rest. When the out-of-policy conditional logic 746 determines that a crew member's current seat assignment does not comply with airline policies, the out-of-policy conditional logic 746 may generate seat preference data that specifies in-policy seat attributes as preferences for the crew member.

With continued reference to FIG. 7C, the out-of-policy conditional logic 746 may determine whether crew members meet qualifications for particular seats based on profile information and seat reservation data specific to crew members. The qualification requirements for crew members may differ from those applied to passengers in the embodiments of FIGS. 7A and 7B. For example, the out-of-policy conditional logic 746 may evaluate crew member seniority, crew type (such as pilot, flight attendant, or other crew classification), duty status, and regulatory compliance requirements when determining whether a crew member qualifies for a particular seat. The out-of-policy conditional logic 746 may reject seat assignments that would place crew members in seats that violate airline policies or regulatory requirements and may generate seat preference data that directs the seat reservation system to reassign the crew member to a policy-compliant seat.

Upon determining that a crew member's seating is out of policy, the out-of-policy conditional logic 746 transmits a save preferences operation to the seats system. The save preferences operation may include seat preference data that specifies in-policy seat attributes as preferences for the crew member. For example, if airline policy requires deadheading pilots to be seated in business class or in specific rows of the aircraft, the out-of-policy conditional logic 746 may generate seat preference data indicating these requirements as preferences for the crew member.

The seats system of the seat preferences system 700C includes components that correspond to similarly numbered components described with reference to FIG. 7A. A database 710C may perform add, update, and get operations for storing and retrieving seat preference data, assignment waitlist information, and seat assignment records in a manner similar to the database 710A. A seat preferences component 712C receives saved preferences from the out-of-policy conditional logic 746 and interfaces with the database 710C to store and manage seat preference data for crew members requiring policy-compliant seat assignments.

An open seat events component 714C monitors seat availability and detects open seat events for scheduled flights. The open seat events component 714C may generate open seat event notifications when seats that meet crew policy requirements become available. An open seat listener 716C receives notifications from the open seat events component 714C and coordinates the seat reassignment process for crew members. The open seat listener 716C retrieves preferences from the seat preferences component 712C and interfaces with a seat recommendation for preference component 718C. The seat recommendation for preference component 718C may generate seat recommendations based on the retrieved seat preference data and available seats that meet crew policy requirements.

In the context of crew seat assignments, the assignment waitlist may rank crew members based on crew status, seniority, and policy compliance rather than the passenger-focused criteria described with reference to FIGS. 7A and 7B. The management engine 311 described with respect to FIG. 3 may generate and maintain the assignment waitlist ranking for crew members based on these crew-specific factors. For example, a senior captain may be ranked higher in the assignment waitlist than a junior first officer, and crew members whose current seat assignments are further out of policy compliance may be prioritized for reassignment over crew members with minor policy deviations.

The seat reservation system may generate seat reassignment plans that prioritize placing crew members in policy-compliant seats while maximizing crew preference fulfillment. The plan selection criteria for crew seat assignment scenarios may include maximizing the number of crew members placed in policy-compliant seats, prioritizing reassignment of crew members with the most severe policy violations, and fulfilling crew preferences where policy compliance permits. The seat reservation system may evaluate each of a plurality of seat reassignment plans against these criteria to determine which plan provides outcomes that ensure policy compliance while accommodating crew preferences to the extent possible.

A seat assignment component 720C finalizes seat assignments based on the final seat reassignment plan generated for the crew seat assignment scenario. The seat assignment component 720C may update seat assignment records and modify seating configurations for the scheduled flight to reflect crew seat reassignments. A notification component 722C receives information from the seat assignment component 720C and transmits notifications of new seat assignments to relevant parties, which may include the crew members, airline operations systems, and other stakeholders involved in crew scheduling and flight operations.

Referring now to FIG. 7D, a paid seat preferences system 700D illustrates an alternative or complimentary embodiment to the seat preferences system 700A of FIG. 7A, the seat preferences system 700B of FIG. 7B, and the seat preferences system 700C of FIG. 7C, specifically configured for passenger assignment to seats requiring a paid upgrade. The paid seat preferences system 700D addresses scenarios where passengers may pay for upgraded seat options, such as premium economy seats, extra legroom seats, or other seat categories that carry additional charges beyond the base fare.

The paid seat preferences system 700D includes a Mobile UX/BFF layer that facilitates user interactions with the seat reservation system in a manner similar to the seat preferences system 700A of FIG. 7A. A first mobile device 702D, a second mobile device 704D, and a third mobile device 708D are illustrative examples that correspond to the first mobile device 702A, the second mobile device 704A, and the third mobile device 708A described with reference to FIG. 7A. Each of the mobile devices 702D, 704D, and 708D may be configured to perform any of the attributed functions described herein, and the system may support more or fewer mobile devices than those depicted in the figures. As such, the mobile devices may facilitate a get offer operation, allowing users to retrieve available paid seat preference options for a scheduled flight. The mobile devices may also facilitate a save preferences operation, enabling users to submit seat preference data indicating willingness to pay for upgraded seats. The mobile devices may also facilitate get preferences operations and get wallet details operations, allowing users to retrieve previously stored seat preference data and payment credential information. A Mobile/Dotcom services component 706D corresponds to the Mobile/Dotcom services component 706A described with reference to FIG. 7A and receives and processes user interactions from the mobile devices.

With continued reference to FIG. 7D, the paid seat preferences system 700D includes an Offer pricing layer that differentiates the paid seat preferences system 700D from the non-paid reassignment scenarios of FIGS. 7A-7C. The Offer pricing layer includes a merch service component 760 that returns offer quotes and offer prices for upgraded seat options. The merch service component 760 may interface with the Mobile/Dotcom services component 706D to provide pricing information for available premium seats, extra legroom seats, and other paid seat categories. When a passenger requests seat preference options through the first mobile device 702D, the merch service component 760 may generate and return pricing quotes for each available upgraded seat option, enabling passengers to make informed decisions about paid seat preferences.

The paid seat preferences system 700D includes a Payment layer that manages payment credentials and processes upgrade charges for paid seat assignments. The Payment layer includes a save pax wallet component 762 that stores payment credentials, such as credit card details, for passengers who wish to participate in paid seat reassignment. When a passenger submits seat preference data indicating willingness to pay for an upgraded seat, the save pax wallet component 762 may store the passenger's payment credentials for use when a matching paid seat becomes available.

The Payment layer further includes a pax wallet lookup details component 764 that retrieves wallet information and payment credentials when processing paid seat assignments. The pax wallet lookup details component 764 may interface with the save pax wallet component 762 to obtain stored payment credentials for passengers selected for paid seat reassignment. A payment fulfillment component 766 processes upgrade charges when passengers are assigned to paid seats. The payment fulfillment component 766 may charge the passenger's stored payment credentials and handle payment processing workflows, including scenarios where stored payment credentials may have expired or become invalid.

The paid seat preferences system 700D includes a seat fulfillment orchestrator component 768 that coordinates the paid seat fulfillment workflow. The seat fulfillment orchestrator component 768 may orchestrate interactions between the seats system components and the Payment layer components to ensure that seat assignments and payment processing occur in a coordinated manner. The seat fulfillment orchestrator component 768 may trigger charge payment operations to the payment fulfillment component 766 when a passenger is selected for a paid seat assignment, ensuring that payment is processed before the seat assignment is finalized.

The paid seat preferences system 700D includes a Shopping cart/EMD layer that manages electronic miscellaneous documents and receipts for paid seat transactions. An EMD component 770 creates electronic miscellaneous document records and assigns seats based on instructions from the seat assignment component 720D. The EMD component 770 may generate electronic records documenting the paid seat upgrade transaction for airline accounting and passenger record-keeping purposes. A receipts component 772 receives receipt data from the EMD component 770 and may generate and transmit receipts to passengers confirming their paid seat upgrade transactions.

The seats system of the paid seat preferences system 700D includes components that correspond to similarly numbered components described with reference to FIG. 7A. A database 710D may perform add, update, and get operations for storing and retrieving seat preference data, assignment waitlist information, payment credential references, and seat assignment records in a manner similar to the database 710A. A seat preferences component 712D receives saved preferences from the Mobile/Dotcom services component 706D and interfaces with the database 710D to store and manage seat preference data for passengers interested in paid seat upgrades.

An open seat events component 714D monitors seat availability and detects open seat events for paid seat categories on scheduled flights. The open seat events component 714D may generate open seat event notifications when premium seats, extra legroom seats, or other paid seat categories become available. An open seat listener 716D receives notifications from the open seat events component 714D and coordinates the paid seat reassignment process. The open seat listener 716D retrieves preferences from the seat preferences component 712D and interfaces with a seat recommendation for preference component 718D. The seat recommendation for preference component 718D may generate seat recommendations based on the retrieved seat preference data, available paid seats, and upgrade pricing information.

In the context of paid seat assignments, the assignment waitlist may rank passengers based on willingness to pay for upgrades and stored payment credentials in addition to the passenger preference criteria described with reference to FIG. 7A. The management engine 311 described with respect to FIG. 3 may generate and maintain the assignment waitlist ranking for paid seat scenarios based on factors including passenger willingness to pay indicated upgrade prices, validity of stored payment credentials, passenger status data, and times at which seat preference data was received. For example, a passenger who has indicated willingness to pay for a premium seat upgrade and has valid stored payment credentials may be ranked higher in the assignment waitlist than a passenger who has not stored payment credentials or who has indicated a lower willingness to pay.

The seat reservation system may generate seat reassignment plans that factor in upgrade pricing and payment processing to maximize revenue while fulfilling passenger preferences for premium seats. The plan selection criteria for paid seat assignment scenarios may include maximizing total revenue from paid seat upgrades, maximizing the number of passengers who receive their preferred paid seat categories, and prioritizing passengers with valid stored payment credentials to ensure successful payment processing. The seat reservation system may evaluate each of a plurality of seat reassignment plans against these criteria to determine which plan provides outcomes that balance revenue generation with passenger preference fulfillment.

A seat assignment component 720D finalizes seat assignments based on the final seat reassignment plan generated for the paid seat assignment scenario. The seat assignment component 720D may interface with the seat fulfillment orchestrator component 768 to coordinate payment processing before finalizing seat assignments. The seat assignment component 720D may update seat assignment records and modify seating configurations for the scheduled flight to reflect paid seat reassignments. A notification component 722D receives information from the seat assignment component 720D and transmits notifications of new seat assignments to user devices associated with passengers who have been assigned to paid seats. The notification component 722D may include confirmation of the paid upgrade transaction and receipt information in the notifications transmitted to passengers.

Referring now to FIG. 7E, a seat preferences system 700E illustrates an alternative or complementary embodiment to the seat preferences system 700A of FIG. 7A, the seat preferences system 700B of FIG. 7B, the seat preferences system 700C of FIG. 7C, and the paid seat preferences system 700D of FIG. 7D, specifically configured for enhanced seat assignment using artificial intelligence and machine learning (AIML). The seat preferences system 700E may be used to replace or supplement any of the embodiments described with reference to FIGS. 7A-7D, providing machine learning capabilities for generating and selecting seat reassignment plans. The AIML-enhanced embodiment of FIG. 7E may leverage the machine learning techniques described with respect to the assignment server 302 of FIG. 1 and the matching engine 314a of FIG. 3 to provide automated, optimized seat reassignment functionality.

The seat preferences system 700E includes a Use cases section that feeds various seat assignment scenarios into the seats system. A crew seat assignments use case 748 corresponds to the crew seat assignment functionality described with reference to the seat preferences system 700C of FIG. 7C, enabling the seat preferences system 700E to process seat assignments for deadheading pilots and other crew members. A seat reaccommodation use case 750 corresponds to the aircraft change functionality described with reference to the seat preferences system 700B of FIG. 7B, enabling the seat preferences system 700E to process seat reassignments triggered by aircraft type changes or operational aircraft swaps. A passenger preferences use case 752 corresponds to the passenger preference functionality described with reference to the seat preferences system 700A of FIG. 7A, enabling the seat preferences system 700E to process seat reassignments based on passenger-submitted seat preference data. A paid seat preferences use case 754 corresponds to the paid seat upgrade functionality described with reference to the paid seat preferences system 700D of FIG. 7D, enabling the seat preferences system 700E to process paid seat reassignments for passengers willing to pay for upgraded seats. A family adjacency use case 756 enables the seat preferences system 700E to process seat reassignments for passengers who have indicated a preference to sit adjacent to other passengers on the same flight, such as family members traveling together.

With continued reference to FIG. 7E, each of the use cases 748, 750, 752, 754, and 756 transmits a save preferences operation to the seats system for storage and processing. The save preferences operation may include seat preference data generated by the respective use case, enabling the seat preferences system 700E to maintain a unified assignment waitlist that incorporates seat assignment requests from crew members, passengers affected by aircraft changes, passengers with seat preferences, passengers interested in paid upgrades, and passengers requesting family adjacency seating. The preferences may include those selected by passengers via user devices such as the first mobile device 702A, the second mobile device 704A, and the third mobile device 708A described with reference to FIG. 7A, or through other input methods described in the preceding sections, including preferences generated automatically by the seat reaccommodation component 740 in response to aircraft changes or by the out-of-policy conditional logic 746 for crew seating compliance.

The seats system of the seat preferences system 700E includes a database 710E that may perform add, update, and get operations for storing and retrieving seat preference data, assignment waitlist information, and seat assignment records in a manner similar to the database 710A described with reference to FIG. 7A. A seat preferences component 712E receives saved preferences from the various use cases and interfaces with the database 710E to store and manage seat preference data. The seat preferences component 712E corresponds to the seat preferences component 712A described with reference to FIG. 7A.

An open seat events component 714E monitors seat availability and detects open seat events for scheduled flights. The open seat events component 714E corresponds to the open seat events component 714A described with reference to FIG. 7A and may generate open seat event notifications based on seat cancellations, upgrades, operational seat assignments, or aircraft configuration changes. An open seat listener 716E receives notifications from the open seat events component 714E and coordinates the seat reassignment process. The open seat listener 716E corresponds to the open seat listener 716A described with reference to FIG. 7A and retrieves preferences from the seat preferences component 712E.

The seat preferences system 700E includes an AIML component 758 that differentiates the seat preferences system 700E from the embodiments of FIGS. 7A-7D. The AIML component 758 is configured to choose the passenger and the seat for assignment using machine learning techniques. The open seat listener 716E interfaces with the AIML component 758 to leverage machine learning capabilities for generating and selecting seat reassignment plans.

The AIML component 758 may process an indication of open seats, the assignment waitlist, seat preference data, and aircraft plan data for the scheduled flight with a matching machine learning model trained to generate the final seat reassignment plan according to plan selection criteria. The indication of open seats may include information about newly available seats detected by the open seat events component 714E. The assignment waitlist may include rankings of passengers based on seat reservation data, seat preference data, passenger status data, and times at which seat preference data was received, as described with reference to the management engine 311 of FIG. 3. The seat preference data may include one or more ranked preferences per passenger, such as window seat preferences, aisle seat preferences, extra legroom preferences, and adjacent seating preferences. The aircraft plan data may include seating configuration information for the scheduled flight, including seat locations, seat attributes, cabin class designations, and seat availability status.

The matching machine learning model employed by the AIML component 758 may be trained on historical assignment waitlists, historical seat preference data, and historical aircraft plan data associated with known seat reassignment plans that satisfy the plan selection criteria. The historical assignment waitlists may include past rankings of passengers and the factors used to generate those rankings. The historical seat preference data may include past passenger preferences and the outcomes of seat reassignments based on those preferences. The historical aircraft plan data may include past seating configurations and the seat assignments that resulted from various reassignment scenarios. The known seat reassignment plans that satisfy the plan selection criteria may serve as training examples that enable the matching machine learning model to learn patterns for generating optimized seat reassignment plans.

In some embodiments, the AIML component 758 may process an indication of the open seat, the assignment waitlist, and the seat preference data with a machine learning model to generate a plurality of seat reassignment plans as described herein. Each of the plurality of seat reassignment plans may differently fill the new open seat and subsequently opened seats from passengers included on the assignment waitlist using the seat preference data. The AIML component 758 may evaluate multiple factors simultaneously to generate seat reassignment plans that account for passenger rankings, seat preferences, aircraft configurations, and the cascading effects of reassigning passengers from one seat to another.

To select the final seat reassignment plan, the AIML component 758 may process the plan selection criteria and the plurality of seat reassignment plans with the machine learning model to select the final seat reassignment plan. The plan selection criteria may include maximizing total passengers removed from the assignment waitlist, maximizing a number of highest ranked passengers removed from the assignment waitlist, maximizing a number of adjacent seating requests from the assignment waitlist that are fulfilled, or maximizing a total number of highest ranked preferences fulfilled. The machine learning model may evaluate each of the plurality of seat reassignment plans against the plan selection criteria to determine which plan provides the optimal outcome.

The AIML component 758 may dynamically rank passengers in the assignment waitlist using learned patterns from the historical data. Unlike rule-based algorithms that apply fixed weights to ranking factors, the machine learning model may identify complex relationships between passenger attributes, seat preferences, and successful reassignment outcomes that enable more nuanced ranking decisions. For example, the machine learning model may learn that passengers with certain combinations of preferences and profile attributes are more likely to accept reassignment offers or be pleased with automatic reassignments, enabling the AIML component 758 to prioritize those passengers when generating seat reassignment plans.

The AIML component 758 may generate optimized seat reassignment plans by processing multiple factors simultaneously to maximize plan selection criteria. The machine learning model may consider the interactions between different passengers on the assignment waitlist, the available seats on the aircraft, and the cascading effects of each potential reassignment to identify seat reassignment plans that satisfy the plan selection criteria to a greater degree than plans generated through sequential rule-based processing. For example, when processing a family adjacency request from the family adjacency use case 756, the AIML component 758 may identify reassignment sequences that open adjacent seats for family members while also satisfying preferences of other passengers on the assignment waitlist.

A seat assignment component 720E finalizes seat assignments based on the final seat reassignment plan generated by the AIML component 758. The seat assignment component 720E corresponds to the seat assignment component 720A described with reference to FIG. 7A and may update seat assignment records and modify seating configurations for the scheduled flight. A notification component 722E receives information from the seat assignment component 720E and transmits notifications of new seat assignments to user devices associated with reassigned passengers. The notification component 722E corresponds to the notification component 722A described with reference to FIG. 7A.

The features and functions described with reference to FIGS. 7A-7E may also be directed to alternative formats and embodiments. In particular, the described features and functions may be performed as a method executed by any of the systems and processing components described herein and/or by a processing component of any of the systems described above executing corresponding instructions stored on a tangible, non-transitory computer-readable medium. These processing components may include the assignment server 302, the comprehensive seat assignment system 100, or any of the seat preferences systems 700A-700E. In some embodiments, the processing components may include one or more of the qualification engine 310 shown in FIG. 3, the management engine 311 shown in FIG. 3, the detection engine 312 shown in FIG. 3, the matching engine 314a shown in FIG. 3, the assignment engine 314b shown in FIG. 3, the notification engine 314c shown in FIG. 3, the open seat listeners 716A-716E shown in FIGS. 7A-7E, the seat recommendation for preference components 718A-718E shown in FIGS. 7A-7D, the AIML component 758 shown in FIG. 7E, and the seat assignment components 720A-720E shown in FIGS. 7A-7E.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines, and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for evaluating reliability of a response generated by a language model through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

What is claimed is:

1. A seat reservation system comprising:
one or more processors; and
one or more non-transitory, computer-readable media storing instructions that, when executed by the one or more processors, cause the seat reservation system to:
detect an open seat event indicating availability of a new open seat for a scheduled flight;
suspend manual seat change requests in response to detecting the open seat event;
generate a final seat reassignment plan for the scheduled flight, wherein the final seat reassignment plan fills the new open seat and one or more subsequently opened seats from passengers included on an assignment waitlist using seat preference data for each passenger included on the assignment waitlist, and wherein the one or more subsequently opened seats include seats opened in response to filling of the new open seat with a passenger from the assignment waitlist;
update the assignment waitlist to remove reassigned passengers moved to the new open seat and subsequently opened seats in the final seat reassignment plan;
transmit one or more notifications of new seat assignments from the final seat reassignment plan to user devices associated with the reassigned passengers; and
reenable the manual seat change requests in response to selecting the final seat reassignment plan.

2. The seat reservation system of claim 1 wherein to generate the final seat reassignment plan, the instructions, when executed by the one or more processors, cause the seat reservation system to:
generate a plurality of seat reassignment plans for the scheduled flight, wherein each of the plurality of seat reassignment plans differently fills the new open seat and subsequently opened seats from passengers included on the assignment waitlist using the seat preference data; and
selects the final seat reassignment plan from the plurality of seat reassignment plans, wherein the final seat reassignment plan best satisfies plan selection criteria as compared to other ones of the plurality of seat reassignment plans.

3. The seat reservation system of claim 2, wherein to generate the plurality of seat reassignment plans, the instructions, when executed by the one or more processors, cause the seat reservation system to:
process an indication of the new open seat, the assignment waitlist, and the seat preference data, with a machine learning model to generate the plurality of seat reassignment plans.

4. The seat reservation system of claim 3 wherein to select the final seat reassignment plan, the instructions, when executed by the one or more processors, cause the seat reservation system to:
process the plan selection criteria and the plurality of seat reassignment plans with the machine learning model to select the final seat reassignment plan.

5. The seat reservation system of claim 2 wherein to select the final seat reassignment plan, the instructions, when executed by the one or more processors, cause the seat reservation system to:
rank the plurality of seat reassignment plans based on a degree to which each of the plurality of seat reassignment plans satisfies the plan selection criteria; and
select a highest ranked one of the plurality of seat reassignment plans as the final seat reassignment plan.

6. The seat reservation system of claim 2 wherein:
the assignment waitlist includes a ranking of the passengers that is based on at least one of: seat reservation data of the passengers, the seat preference data, passenger profile data, or times at which the seat preference data was received;
the seat preference data includes one or more ranked preferences per passenger; and
the plan selection criteria includes one of: maximizing total passengers removed from the seat assignment waitlist, maximizing a number of highest ranked passengers removed from the seat assignment waitlist, maximizing a number of adjacent seating requests from the seat assignment waitlist that are fulfilled, or maximizing a total number of highest ranked preferences fulfilled.

7. The seat reservation system of claim 1 wherein:
to generate the final seat reassignment plan, the instructions, when executed by the one or more processors, cause the seat reservation system to process an indication of the new open seat, the assignment waitlist, the seat preference data, aircraft plan data for the scheduled flight, with a matching machine learning model trained to generate the final seat reassignment plan according to a plan selection criteria;
the assignment waitlist includes a ranking of the passengers that is based on at least one of: seat reservation data of the passengers, the seat preference data, passenger profile data, or times at which the seat preference data was received;
the seat preference data includes one or more ranked preferences per passenger; and
the plan selection criteria includes one of: maximizing total passengers removed from the seat assignment waitlist, maximizing a number of highest ranked passengers removed from the seat assignment waitlist, maximizing a number of adjacent seating requests from the seat assignment waitlist that are fulfilled, or maximizing a total number of highest ranked preferences fulfilled.

8. The seat reservation system of claim 7 wherein the matching machine learning model is trained on historical assignment waitlists, historical seat preference data, and historical aircraft plan data associated with known seat reassignment plans that satisfy the plan selection criteria.

9. The seat reservation system of claim 1, wherein the seat preference data includes one or more ranked preferences per passenger and the instructions, when executed by the one or more processors, cause the seat reservation system to:
retain, on the assignment waitlist, reassigned passengers for which a reassigned seat in the final seat reassignment plan fails to meet a respective highest ranked preference.

10. The seat reservation system of claim 1, wherein the seat preference data includes at least one of: a window seat preference, an aisle seat preference, a middle seat with extra legroom preference, preference for adjacent seats with another passenger, avoidance of exit row seats, avoidance of bulkhead seats, avoidance of middle seats, or avoidance of middle seats with extra legroom.

11. The seat reservation system of claim 1, wherein to generate the final seat reassignment plan the instructions, when executed by the one or more processors, cause the seat reservation system to:
determine, via a qualification engine, whether a passenger on the assignment waitlist meets qualifications for the new open seat and subsequently opened seats based on at least one of: the seat preference data, seat reservation data for the passengers, profile information of the passengers, or past history of the passengers.

12. The seat reservation system of claim 1, wherein the new open seat is classified into a particular cabin class among different cabin classes and to generate the final seat reassignment plan the instructions, when executed by the one or more processors, cause the seat reservation system to:
determine the passengers on the assignment waitlist eligible for the new open seat based on one or more of the particular cabin class, the seat preference data, and profile information of the passengers; and
assign a passenger from the assignment waitlist that is eligible to sit in the cabin class of the new open seat to the new open seat in the final seat reassignment plan.

13. The seat reservation system of claim 1, wherein the assignment waitlist includes an ordering of the passengers that is based on at least one of: seat reservation data for the passengers, the seat preference data, or times at which the seat preference data was received.

14. The seat reservation system of claim 1, wherein the open seat event is generated based on at least one of: a seat cancellation of the new open seat, an upgrade of the new open seat to another seat, or an operational seat assignment.

15. The seat reservation system of claim 1, wherein the instructions, when executed by the one or more processors, cause the seat reservation system to:
stop detecting future open seat events within a predetermined time period prior to a set takeoff time of the scheduled flight.

16. The seat reservation system of claim 1, wherein the instructions, when executed by the one or more processors, cause the seat reservation system to:
provide a plurality of seat preference options for a seat reservation to passengers via user devices associated with passengers for the scheduled flight; and
compile the seat preference data based on selections of the plurality of seat preference options via the user devices.

17. A method of generating a final seat reassignment plan for a scheduled flight in response to an open seat event, the method comprising:
detecting, by one or more processors, the open seat event indicating availability of a new open seat for the scheduled flight;
suspending, by the one or more processors, manual seat change requests in response to detecting the open seat event;
generating, by the one or more processors, a final seat reassignment plan for the scheduled flight, wherein the final seat reassignment plan fills the new open seat and one or more subsequently opened seats from passengers included on an assignment waitlist using seat preference data for each passenger included on the assignment waitlist, and wherein the one or more subsequently opened seats include seats opened in response to filling of the new open seat with a passenger from the assignment waitlist;
updating, by the one or more processors, the assignment waitlist to remove reassigned passengers moved to the new open seat and subsequently opened seats in the final seat reassignment plan;
transmitting, by the one or more processors, one or more notifications of new seat assignments from the final seat reassignment plan to user devices associated with the reassigned passengers; and
reenabling, by the one or more processors, the manual seat change requests in response to selecting the final seat reassignment plan.

18. The method of claim 17 wherein:
generating the final seat reassignment plan includes processing by the one or more processors, an indication of the new open seat, the assignment waitlist, the seat preference data, aircraft plan data for the scheduled flight, with a matching machine learning model trained to generate the final seat reassignment plan according to a plan selection criteria;
the assignment waitlist includes a ranking of the passengers that is based on at least one of: seat reservation data of the passengers, the seat preference data, passenger profile data, or times at which the seat preference data was received;
the seat preference data includes one or more ranked preferences per passenger; and
the plan selection criteria includes one of: maximizing total passengers removed from the seat assignment waitlist, maximizing a number of highest ranked passengers removed from the seat assignment waitlist, maximizing a number of adjacent seating requests from the seat assignment waitlist that are fulfilled, or maximizing the total number of highest ranked preferences fulfilled.

19. A tangible, non-transitory computer-readable medium storing instructions for generating a final seat reassignment plan for a scheduled flight in response to an open seat event, wherein the instructions, when executed by one or more processors of a seat reservation system, cause the seat reservation system to:
detect the open seat event indicating availability of a new open seat for the scheduled flight;
suspend manual seat change requests in response to detecting the open seat event;
generate a final seat reassignment plan for the scheduled flight, wherein the final seat reassignment plan fills the new open seat and one or more subsequently opened seats from passengers included on an assignment waitlist using seat preference data for each passenger included on the assignment waitlist, and wherein the one or more subsequently opened seats include seats opened in response to filling of the new open seat with a passenger from the assignment waitlist;
update the assignment waitlist to remove reassigned passengers moved to the new open seat and subsequently opened seats in the final seat reassignment plan;
transmit one or more notifications of new seat assignments from the final seat reassignment plan to user devices associated with the reassigned passengers; and
reenable the manual seat change requests in response to selecting the final seat reassignment plan.

20. The tangible, non-transitory computer-readable medium of claim 19 wherein:
to generate the final seat reassignment plan, the instructions, when executed by the one or more processors, cause the seat reservation system to process an indication of the new open seat, the assignment waitlist, the seat preference data, aircraft plan data for the scheduled flight, with a matching machine learning model trained to generate the final seat reassignment plan according to a plan selection criteria;
the assignment waitlist includes a ranking of the passengers that is based on at least one of: seat reservation data of the passengers, the seat preference data, passenger profile data, or times at which the seat preference data was received;
the seat preference data includes one or more ranked preferences per passenger; and
the plan selection criteria includes one of: maximizing total passengers removed from the seat assignment waitlist, maximizing a number of highest ranked passengers removed from the seat assignment waitlist, maximizing a number of adjacent seating requests from the seat assignment waitlist that are fulfilled, or maximizing the total number of highest ranked preferences fulfilled.
